(19) United States
(12) Patent Application Publication
(10) Pub. No.: US 2024/0113527 A1
(43) Pub. Date: Apr. 4, 2024

(54) SYSTEM FOR VOLTAGE-CONTROLLED POWER GRID REGULATION BASED UPON INPUT VARIABLE ENERGY SOURCES

(71) Applicant: Rondo Energy, Inc., Alameda, CA (US)

(72) Inventors: Robert RATZ, San Jose, CA (US); John Setel O'DONNELL, Oakland, CA (US)

(21) Appl. No.: 18/376,797

(22) Filed: Oct. 4, 2023

Related U.S. Application Data
(60) Provisional application No. 63/378,355, filed on Oct. 4, 2022.
(60) Provisional application No. 63/427,374, filed on Nov. 22, 2022.
(60) Provisional application No. 63/434,919, filed on Dec. 22, 2022.
(60) Provisional application No. 63/459,540, filed on Apr. 14, 2023.
(60) Provisional application No. 63/578,139, filed on Aug. 22, 2023.

(51) Int. Cl. H02J 3/46; H02J 3/00; H02J 3/12; H02J 3/32; H02J 3/38

(52) U.S. Cl. CPC H02J 3/46; H02J 3/007; H02J 3/12; H02J 3/32; H02J 3/381; H02J 2300/24; H02J 2300/28

(57) ABSTRACT

An energy storage system (TES) converts variable renewable electricity (VRE) to continuous heat at over 1000° C. Intermittent electrical energy heats a solid medium. Heat from the solid medium is delivered continuously on demand. Heat delivery via flowing gas establishes a thermocline which maintains high outlet temperature throughout discharge. The delivered heat which may be used for processes including power generation and cogeneration. In one application, the energy storage system is engaged to a power grid by one or more load circuits, and renewable energy sources supply power to the power grid through the use of novel inverters to match the load that is provided to the power grid.

### CROSS-REFERENCE TO RELATED APPLICATIONS

This application claims priority under 35 USC § 119(e) to:
U.S. Provisional Patent Application No. 63/378,355 filed on Oct. 4, 2022,
U.S. Provisional Patent Application No. 63/427,374 filed on Nov. 22, 2022,
U.S. Provisional Patent Application No. 63/434,919 filed on Dec. 22, 2022,
U.S. Provisional Patent Application No. 63/459,540 filed on Apr. 14, 2023,
and
U.S. Provisional Patent Application No. 63/578,139 filed on Aug. 22, 2023.

The contents of these priority applications are incorporated by reference in their entirety and for all purposes.

Additionally, the following patent applications are directed to related technologies, and are incorporated by reference in their entirety for all purposes:
U.S. patent application Ser. No. 17/537,407 (filed Nov. 29, 2021; issued as U.S. Pat. No. 11,603,776 on Mar. 14, 2023), and
International Patent Application No.: PCT/US2021/061041 (filed Nov. 29, 2021).

### BACKGROUND

### Technical Field

The present disclosure relates to systems that deliver heat from electrical energy, including electrode boilers and electric thermal energy storage and utilization systems, and including systems where the electrical energy is provided by renewable sources. More particularly, the present disclosure relates to a system which efficiently captures and utilizes electricity from renewable generation sources such as wind and solar energy and powers electrical loads which deliver heat, including continuous heat, without requiring the use of high-power equipment other than the electrical loads themselves to establish microgrid operating conditions in a relatively constant, stable state despite unpredictable and varying generation. Conventional microgrids include a connection to an external electricity grid or devices such as batteries or generators to maintain operating parameters including voltage. More specifically, the present disclosure covers a system which transfers electrical energy from one or more DC variable sources, whose output is derived from wind or solar energy and is unpredictable and only partially controllable, through one or more inverters tied to a common AC electrical connection, referred to here as a microgrid, to one or more controllable electrical loads which convert electricity to heat, without requiring connection to an external grid and without requiring devices such as batteries and generators (but also without requiring their exclusion). Such controllable electrical loads may be resistive electrical heaters in an industrial facility such as a kiln or oven, resistive heaters within an electrode boiler, resistive ionic conduction within an electrode boiler, or resistive heaters supplying heat to a thermal energy storage device. Some of these electrical loads, such as kiln and boiler heaters, may deliver heat to an industrial use only during periods when electricity is being supplied, at the instantaneous rate of availability of such electricity; others, such as electric thermal energy storage systems, may accept heat only during periods when electricity is being supplied, at the instantaneous rate of availability of such electricity, but deliver heat to an industrial use relatively continuously, thus converting a lower-value variable resource into a higher-value continuous resource. A single “device” such as an electric furnace, electrode boiler, or electric thermal storage unit may incorporate only one controllable load, or a single device may incorporate a plurality of independently controllable loads; thus a microgrid may incorporate one or a plurality of such devices or any mix thereof.

It is common for microgrid systems that incorporate variable renewable electricity (VRE) sources such as wind and solar generation to require at least one device such as a generator or battery, or a connection to a larger electricity grid, in order to establish microgrid frequency and voltage for reliable operation. The present innovations enable the reliable, efficient transfer of all available power to one or more microgrid-connected loads without requiring such devices or grid connection

The disclosure covers a local electricity microgrid and one or more sources of variable power, including inverters whose input power comes from wind turbines or solar panels. More specifically, to transfer electrical energy to the energy storage system from variable renewable energy sources, a system involving voltage-controlled inverters is used to convert energy from the variable renewable energy sources to the microgrid by controlling output voltage levels to accomplish purposes such as, but not limited to, maximizing power to the microgrid. The microgrid operational parameters can be regulated by the actions of Maximum Power Point Tracking (MPPT) controllers operating in voltage control mode in the inverters connected to the microgrid, and by a controller selectively connecting or disconnecting electrical loads to the microgrid based on parameters including microgrid voltage. The microgrid can be created solely by the variable renewable energy sources and does not rely on any sort of grid-forming device to be connected to a predictable power source such as battery, fossil fuel power generators or an external electricity grid.

### Related Art

I. Thermal Energy Systems

A. Variable Renewable Electricity

The combustion of fossil fuels has been used as a heat source in thermal electrical power generation to provide heat and steam for uses such as industrial process heat. The use of fossil fuels has various problems and disadvantages, however, including global warming and pollution. Accordingly, there is a need to switch from fossil fuels to clean and sustainable energy.

Variable renewable electricity (VRE) sources such as solar power and wind power have grown rapidly, as their costs have reduced as the world moves towards lower carbon emissions to mitigate climate change. But a major challenge relating to the use of VRE is, as its name suggests, its variability. The variable and intermittent nature of wind and solar power does not make these types of energy sources natural candidates to supply the continuous energy demands of electrical grids, industrial processes, etc. Accordingly, there is an unmet need for storing VRE to be able to efficiently and flexibly deliver energy at different times.

Moreover, the International Energy Agency has reported that the use of energy by industry comprises the largest portion of world energy use, and that three-quarters of industrial energy is used in the form of heat, rather than electricity. Thus, there is an unmet need for lower-cost energy storage systems and technologies that utilize VRE to provide industrial process energy, which may expand VRE and reduce fossil fuel combustion.

B. Storage of Energy as Heat

Thermal energy in industrial, commercial, and residential applications may be collected during one time period, stored in a storage device, and released for the intended use during another period. Examples include the storage of energy as sensible heat in tanks of liquid, including water, oils, and molten salts; sensible heat in solid media, including rock, sand, concrete and refractory materials; latent heat in the change of phase between gaseous, liquid, and solid phases of metals, waxes, salts and water; and thermochemical heat in reversible chemical reactions which may absorb and release heat across many repeated cycles; and media that may combine these effects, such as phase-changing materials embedded or integrated with materials which store energy as sensible heat. Thermal energy may be stored in bulk underground, in the form of temperature or phase changes of subsurface materials, in contained media such as liquids or particulate solids, or in self-supporting solid materials.

Electrical energy storage devices such as batteries typically transfer energy mediated by a flowing electrical current. Some thermal energy storage devices similarly transfer energy into and out of storage using a single heat transfer approach, such as convective transfer via a flowing liquid or gas heat transfer medium. Such devices use “refractory” materials, which are resistant to high temperatures, as their energy storage media. These materials may be arranged in configurations that allow the passage of air and combustion gases through large amounts of material.

Some thermal energy systems may, at their system boundary, absorb energy in one form, such as incoming solar radiation or incoming electric power, and deliver output energy in a different form, such as heat being carried by a liquid or gas. But thermal energy storage systems must also be able to deliver storage economically. For sensible heat storage, the range of temperatures across which the bulk storage material—the “storage medium”—can be heated and cooled is an important determinant of the amount of energy that can be stored per unit of material. Thermal storage materials are limited in their usable temperatures by factors such as freezing, melting, softening, boiling, or thermally driven decomposition or deterioration, including chemical and mechanical effects.

Further, different uses of thermal energy—different heating processes or industrial processes—require energy at different temperatures. Electrical energy storage devices, for example, can store and return electrical energy at any convenient voltage and efficiently convert that voltage up or down with active devices. On the other hand, the conversion of lower-temperature heat to higher temperatures is intrinsically costly and inefficient. Accordingly, a challenge in thermal energy storage devices is the cost-effective delivery of thermal energy with heat content and at a temperature sufficient to meet a given application.

Some thermal energy storage systems store heat in a liquid that flows from a “cold tank” through a heat exchange device to a “hot tank” during charging, and then from the hot tank to the cold tank during discharge, delivering relatively isothermal conditions at the system outlet during discharge. Systems and methods to maintain sufficient outlet temperature while using lower-cost solid media are needed.

Thermal energy storage systems generally have costs that are primarily related to their total energy storage capacity (how many MWh of energy are contained within the system) and to their energy transfer rates (the MW of instantaneous power flowing into or out of the energy storage unit at any given moment). Within an energy storage unit, energy is transferred from an inlet into storage media, and then transferred at another time from storage media to an outlet. The rate of heat transfer into and out of storage media is limited by factors including the heat conductivity and capacity of the media, the surface area across which heat is transferring, and the temperature difference across that surface area. High rates of charging are enabled by high temperature differences between the heat source and the storage medium, high surface areas, and storage media with high heat capacity and/or high thermal conductivity.

Each of these factors can add significant cost to an energy storage device. For example, larger heat exchange surfaces commonly require 1) larger volumes of heat transfer fluids, and 2) larger surface areas in heat exchangers, both of which are often costly. Higher temperature differences require heat sources operating at relatively higher temperatures, which may cause efficiency losses (e.g., radiation or convective cooling to the environment, or lower coefficient of performance in heat pumps) and cost increases (such as the selection and use of materials that are durable at higher temperatures). Media with higher thermal conductivity and heat capacity may also require selection of costly higher-performance materials or aggregates.

Another challenge of systems storing energy from VRE sources relates to rates of charging. A VRE source, on a given day, may provide only a small percentage of its energy during a brief period of the day, due to prevailing conditions. For an energy storage system that is coupled to a VRE source and that is designed to deliver continuous output, all the delivered energy must be absorbed during the period when incoming VRE is available. As a result, the peak charging rate may be some multiple of the discharge rates (e.g., 3-5×), for instance, in the case of a solar energy system, if the discharge period (overnight) is significantly longer than the charge period (during daylight). In this respect, the challenge of VRE storage is different from, for example, that of heat recuperation devices, which typically absorb and release heat at similar rates. For VRE storage systems, the design of units that can effectively charge at high rates is important and may be a higher determinant of total system cost than the discharge rate.

C. Thermal Energy Storage Problems and Disadvantages

The above-described approaches have various problems and disadvantages. Earlier systems do not take into account several critical phenomena in the design, construction, and operation of thermal energy storage systems, and thus does not facilitate such systems being built and efficiently operated. More specifically, current designs fail to address “thermal runaway” and element failure due to non-uniformities in thermal energy charging and discharging across an array of solid materials, including the design of charging, discharging, and unit controls to attain and restore balances in temperature across large arrays of thermal storage material.

Thermal energy storage systems with embedded radiative charging and convective discharging are in principle vulnerable to “thermal runaway” or “heat runaway” effects. The phenomenon may arise from imbalances, even small imbalances, in local heating by heating elements and in cooling by heat transfer fluid flow. The variations in heating rate and cooling rate, unless managed and mitigated, may lead to runaway temperatures that cause failures of heaters and/or deterioration of refractory materials. Overheating causes early failures of heating elements and shortened system life. In Stack, for example, the bricks closest to the heating wire are heated more than the bricks that are further away from the heating wire. As a result, the failure rate for the wire is likely to increase, reducing heater lifetime.

One effect that further exacerbates thermal runaway is the thermal expansion of air flowing in the air conduits. Hotter air expands more, causing a higher outlet velocity for a given inlet flow, and thus a higher hydraulic pressure drops across the conduit, which may contribute to a further reduction of flow and reduced cooling during discharge. Thus, in successive heating and cooling cycles, progressively less local cooling can occur, resulting in still greater local overheating.

The effective operation of heat supply from thermal energy storage relies upon continuous discharge, which is a particular challenge in systems that rely upon VRE sources to charge the system. Solutions are needed that can capture and store that VRE energy in an efficient manner and provide the stored energy as required to a variety of uses, including a range of industrial applications, reliably and without interruption.

Previous systems do not adequately address problems associated with VRE energy sources, including variations arising from challenging weather patterns such as storms, and longer-term supply variations arising from seasonal variations in VRE generation. In this regard, there is an unmet need in the art to provide efficient control of energy storage system charging and discharging in smart storage management. Current designs do not adequately provide storage management that considers a variety of factors, including medium-term through short-term weather forecasts, VRE generation forecasts, and time-varying demand for energy, which may be determined in whole or in part by considerations such as industrial process demand, grid energy demand, real-time electricity prices, wholesale electricity market capacity prices, utility resource adequacy value, and carbon intensity of displaced energy supplies. A system is needed that can provide stored energy to various demands that prioritizes by taking into account these factors, maximizing practical utility and economic efficiencies.

There are a variety of unmet needs relating generally to energy, and more specifically, to thermal energy. Generally, there is a need to switch from fossil fuels to clean and sustainable energy. There is also a need to store VRE to deliver energy at different times in order to help meet society's energy needs. There is also a need for lower-cost energy storage systems and technologies that allow VRE to provide energy for industrial processes, which may expand the use of VRE and thus reduce fossil fuel combustion. There is also a need to maintain sufficient outlet temperature while using lower-cost solid media.

Still further, there is a need to design VRE units that can be rapidly charged at low cost, supply dispatchable, continuous energy as required by various industrial applications despite variations in VRE supply, and that facilitate efficient control of charging and discharging of the energy storage system.

II. Power Grid Regulation

A. Power Grid Regulation Concepts and Methods

With the availability of a variety of variable renewable (or “green”) energy sources (solar panels, wind turbines, etc.), the use of microgrids to supply power to a specific location has increased. As used herein, a microgrid refers to a power grid of a self-sufficient energy system that serves a particular geographic area or a defined functional application. For example, a microgrid may be used to supply power to a medical complex, a business complex, a neighborhood, and the like.

Renewable energy sources that generate a direct current (DC) voltage are incorporated in some microgrids. Such DC voltages can be converted, through the use of inverters (also referred to as “power inverters”), to alternating current (AC) voltages, to transmit power to load circuits coupled to the microgrid.

The power produced by renewable energy sources can vary over time due to environmental changes and the like. For example, the power output of photovoltaic (PV) cells varies based on an illumination level of the photovoltaic cells and the power output of wind turbines varies based on available wind.

In related art implementations of microgrids, a battery-powered grid-forming inverter, generator or similar device with guaranteed power source is utilized to create the AC signal. In such systems, the inverters that are used to convert the energy sources from DC voltage to AC voltage operate in current-control mode. That is, the inverters act as current sources with a high internal impedance. To drive power within the microgrid, the current driven to the microgrid is controlled according to a constant voltage reference signal, or gridline voltage, of the microgrid and the power consumed within the microgrid. Current can be increased or decreased to drive the desired power levels to the microgrid, based on the constant voltage reference signal. The reference grid signal can be driven by an independent power source, such as a turbine generator. An example of such a current-controlled system utilizing distributed generators and a reference diesel generator can be found, for example, in U.S. Pat. No. 9,660,453.

In some systems currently in use, voltage-controlled systems utilizing droop control techniques are supplied by a consistent power source (e.g., a battery) to drive the voltage when the voltage levels drop below a nominal threshold. Such voltage-controlled systems rely on a reference voltage for tracking purposes, as well as on a predictable power source such as the battery. These microgrids are typically sized so that the grid-forming reference can supply the maximum power of the grid when renewable sources are not available. Such a system is described in the aforementioned U.S. Pat. No. 9,660,453.

B. Problems and Disadvantages of Power Grid Regulation Involving Renewable Energy Sources

Current solutions for powering a microgrid with renewable energy sources are complicated and costly. Some inverter circuits use a current-based regulation technique to maintain a constant voltage on the microgrid. Microgrids are typically sized so that their capacity exceeds the nominal power of the load in its specific mode of operation. As a result, overloading of such grids is very rare and is usually based on a failure mode or some sort of misuse. To ensure that a load connected to the microgrid does not attempt to draw more power than is being supplied by the renewable energy sources to the microgrid, conventional microgrid solutions employ an additional piece of hardware such as a control device that monitors the power of the microgrid. Another example of an additional piece of hardware that is used by conventional microgrid solutions involves an energy source containing a power storage medium, such as a battery-powered inverter, that can generate the power to cover the maximum power rating of the designed loads of the microgrid. Those microgrids are designed so that the power source always exceeds the power rating of the loads on the microgrid. When the control device detects a situation where the load demand exceeds the supplied power, the control device can limit the power consumption of one or more load circuits, disconnect one or more load circuits from the microgrid, disable the microgrid voltage signal, and/or take other steps in order to limit the power being drawn from microgrid. Managing the power of the microgrid in this fashion is cumbersome and costly, and in many cases requires additional hardware. It is important to note that microgrids typically do not track source maximum power, but supply power as voltage sources, as consumed. Current solutions for consuming maximum power from a renewable source in a microgrid require an expensive adjustable load and a controlled energy storage.

Present voltage-controlled systems such as droop control systems require a constant energy source that may not be renewable or variable energy sources (e.g., a battery, a turbine or a diesel generator) to drive voltage to the nominal voltage when the voltage tapers off due to fluctuations. Such implementations can be costly depending on the underlying power rating of the load of the microgrid.

### SUMMARY

The example implementations advance the art of thermal energy storage and enable the practical construction and operation of high-temperature thermal energy storage systems which are charged by VRE, store energy in solid media, and deliver high-temperature heat.

I. Thermal Energy Storage System

This Section I of the Summary relates to the disclosure as it appears in U.S. patent application Ser. No. 17/668,333 (U.S. Pat. No. 11,603,776).

Aspects of the example implementations relate to a system for thermal energy storage, including an input (e.g., electricity from a variable renewable electricity (VRE) source), a container having sides, a roof and a lower platform, a plurality of vertically oriented thermal storage units (TSUs), inside the container, the TSUs each including a plurality of stacks of bricks and heaters attached thereto, each of the heaters being connected to the input electricity via switching circuitry, an insulative layer interposed between the plurality of TSUs, the roof and at least one of the sides, a duct formed between the insulative layer and a boundary formed by the sides, an inner side of the roof and the lower platform of the container, a blower that blows relatively cooler fluid such as air or another gas (e.g. CO₂) along the flow path, an output (e.g., hot air at prescribed temperature to industrial application), a controller that controls and co-manages the energy received from the input and the hot air generated at the output based on a forecast associated with an ambient condition (e.g., season or weather) or a condition (e.g., output temperature, energy curve, etc.). The exterior and interior shapes of the container may be rectangular, cylindrical (in which case “sides” refers to the cylinder walls), or other shapes suitable to individual applications.

The terms air, fluid and gas are used interchangeably herein to refer to a fluid heat transfer medium of any suitable type, including various types of gases (air, CO₂, oxygen and other gases, alone or in combination), and when one is mentioned, it should be understood that the others can equally well be used. Thus, for example, “air” can be any suitable fluid or gas or combinations of fluids or gases.

Thermal energy storage (TES) systems according to the present designs can advantageously be integrated with or coupled to steam generators, including heat recovery steam generators (HRSGs) and once-through steam generators (OTSGs). The terms “steam generator”, “HRSG”, and “OTSG” are used interchangeably herein to refer to a heat exchanger that transfers heat from a first fluid into a second fluid, where the first fluid may be air circulating from the TSU and the second fluid may be water (being heated and/or boiled), oil, salt, air, CO₂, or another fluid. In such implementations, the heated first fluid is discharged from a TES unit and provided as input to the steam generator, which extracts heat from the discharged fluid to heat a second fluid, including producing steam, which heated second fluid may be used for any of a variety of purposes (e.g., to drive a turbine to produce shaft work or electricity). After passing through a turbine, the second fluid still contains significant heat energy, which can be used for other processes. Thus, the TES system may drive a cogeneration process. The first fluid, upon exiting the steam generator, can be fed back as input to the TES, thus capturing waste heat to effectively preheat the input fluid. Waste heat from another process may also preheat input fluid to the TES.

According to another aspect, a dynamic insulation system include a container having sides, a roof and a lower platform, a plurality of vertically oriented thermal storage units (TSUs) spaced apart from one another, an insulative layer interposed between the plurality of TSUs, the roof and at least one of the sides and floor, a duct formed between the insulative layer and a boundary formed by the sides, an inner side of the roof and the lower platform of the container, and a blower that blows unheated air along the air flow path, upward from the platform to a highest portion of the upper portion, such that the air path is formed from the highest portion of the roof to the platform, and is heated by the plurality of TSUs, and output from the TES apparatus. The unheated air along the flow path forms an insulated layer and is preheated by absorbing heat from the insulator.

II. Power Grid Regulation—Systems, Methods and Applications

This Section II of the Summary relates to systems and methods for voltage-controlled power grid regulation based on input power levels from variable energy sources.

Power grids are interconnected networks utilized to distribute electricity from energy sources to consumers. Such power grids can include microgrids, which are generally local electrical grids with defined electrical boundaries that can be configured to act as a single and controllable entity. Other examples of power grids can include macrogrids having a regional scale that operate at a synchronized utility frequency and are electrically tied together during normal system conditions. Although example implementations described herein disclose the use of novel load control and inverter circuit functionality with respect to a microgrid, the example implementations may also be generally connected to any type of power grid to facilitate the desired implementation.

Rather than using a separate device capable of absorbing and supplying power and reference voltage to manage the operating parameters of a microgrid powered by variable renewable generation, the embodiments illustrated in the drawings and described herein provide techniques for operating inverter circuits in a voltage-regulation mode to act as variable voltage sources to deliver all currently available power into the microgrid load; and a controller and means to selectively adjust the impedance of loads connected to the microgrid to match the available power while keeping voltage levels of the microgrid within a defined operating region. The inverter circuits each track the available power from their one or more variable energy sources (e.g., solar, wind, etc.) and independently adjust their output voltage waveform seeking to optimize their power delivery in a process referred to as Maximum Power Point Tracking (MPPT). The resulting voltage is a result of the sum of the available power of all the renewable sources and the overall load impedance. For example, if there is one inverter generating one kilowatt of power into a load resulting in 100V RMS (root mean square), two inverters each generating one kilowatt of power for a total of two kilowatts of power into a load will generate 142V (roughly 100V multiplied by the square root of 2). Under the present disclosure the inverters may be started in a sequence, and then independently operate their MPPT processes concurrently within preset ranges, and achieve stable system operation across changing available power (for example, changing illuminance on PV panels) and changing impedance.

In embodiments described herein, the microgrid involves one or more inverter circuits which operate in a voltage-controlled manner and which each, or collectively, incorporate an MPPT controller that adjusts their output AC voltage to optimize their deliverable power, as well as one or more controllable resistive loads, and one or more controllers which measure the voltage of the microgrid and provide control signals to each of a plurality of loads so as to change, from time to time, the total microgrid impedance presented collectively by the loads, so as to maintain the microgrid voltage within a designated operating range. A microgrid may incorporate a combination of VRE sources which have different intrinsic operating characteristics, and may incorporate a set of VRE sources which have different desired operating characteristics.

An inverter circuit has a maximum output voltage at which it can deliver power, a maximum current at which it can deliver power, and a minimum output voltage at which it can deliver power. An inverter controller may accept commands from another system controller which may include an operating mode and a first starting operating voltage at which is to deliver power. Each inverter MPPT controller periodically adjusts the amount of energy delivered to its output by adjustments to the energy it attempts to pass to its output; such changes affect current and voltage of its associated DC renewable energy supply.

In solar PV systems, the MPPT algorithm may seek a relatively optimum voltage and current setting across one or more PV panels so as to optimize power delivery to its output. In conventional applications, including conventional microgrids, the inverter AC connections have low impedance and a relatively fixed voltage, such as an electricity grid, and the MPPT algorithm may be configured to operate in “current mode”, adjusting a target delivery current into a relatively constant voltage waveform (and, as a result, an operating voltage of their interconnected DC power source) to optimize power transfer.

By contrast, in the present disclosure, the inverter circuits are connected to a microgrid which does not have a voltage reference or connection to a larger electricity grid, making current mode operation infeasible. In the present innovation, the MPPT controllers adjust a target voltage waveform to optimize their individual power delivery and the operating voltage and current of their interconnected DC power sources. For a given impedance of the microgrid (that is, the series/parallel total impedance of all loads, as currently configured), the microgrid voltage will vary with changes in the total power being delivered in accordance with the formula Voltage=\sqrt{Power×Impedance}. As available power rises, the microgrid voltage will rise (in part because of the repeated decisions made by the inverter MPPT controllers). During any period during which impedance is fixed, as available power increases (e.g. solar irradiance falling on PV panels increases), the microgrid voltage rises. When power increases cause the rising microgrid voltage reach the inverter maximum voltage, unless impedance is then lowered, no further increases can be made in power being transferred, and further available wind or solar energy is curtailed (lost). The present innovation incorporates a plurality of controllable electric loads and a load controller, which senses microgrid voltage and uses voltage information to cause adjustments in load impedance. In the example case of rising availability of solar power, a rise in microgrid voltage may result a controller issuing a command which lowers the impedance presented to the microgrid, which thus enables more power to be transferred without exceeding the maximum operating voltage. A falling availability of solar power will correspondingly lower the microgrid voltage for a fixed impedance. In such case a load controller sensing dropping microgrid voltage may issue commands which raise the impedance presented to the microgrid, to enable continued power delivery at the lower power rate by maintaining the microgrid within the inverter operating voltage range. In a preferred embodiment, the upper voltage setpoint is below the maximum inverter operating voltage, so that enough load (low enough impedance) is presented to take all available power all the time, up to the total capacity of the load to accept power. In some embodiments, the voltage setpoints at which load is raised and lowered may be some distance apart; for example, 95% and 50% of maximum operating voltage, so that substantial changes in power delivery may occur without requiring changes in load impedance. In other embodiments, the voltage setpoints may be chosen to be closer, for example, 95% and 80%, so that more frequent changes in load impedance may be required. Such choices may be affected by considerations arising from inverter design and selection of the switching elements used to achieve the selected load impedance. In some implementations, for example, infrequent switching of loads may result in mechanical switches being selected; in others, more frequent switching of loads may make semiconductor power control devices preferred.

This innovative combination of these two control algorithms enables stable operation of a microgrid that effectively transfers all available power without requiring devices such as generators or batteries to balance or smooth changes in load and changes in available generation.

Aspects of the present disclosure can involve a system for voltage regulation of a microgrid with load circuits coupled to the microgrid, which can include one or more inverter circuits, the one or more inverter circuits configured to: receive input direct current (DC) voltage levels from one or more variable energy sources; generate output alternating current (AC) voltage levels on the microgrid based upon the power levels of the input DC voltages; and adjust the output AC voltage levels based on available power levels received from the variable energy source(s), to regulate output power from the microgrid to the load circuits.

The system advantageously achieves a variable-voltage power grid that adapts to the available power being supplied by renewable energy sources, without the additional complexity and cost associated with prior techniques for implementing such a power grid, which may rely on one or more additional devices requiring independent power sources. The system also allows for a higher amount of power to be controlled with existing active electronics.

The present disclosure teaches a method corresponding to such a voltage regulation system, for voltage regulation of a microgrid with load circuits coupled to the microgrid, the method including: receiving input direct current (DC) power from one or more variable energy sources; generating output alternating current (AC) voltage levels on the microgrid based upon the power levels of the input DC voltages; and adjusting the output AC voltage levels to deliver power to the microgrid based on available power levels received from the variable energy source(s), to regulate output power from the microgrid to the load circuits.

The present disclosure also teaches a system for voltage regulation of a power grid with load circuits coupled to the power grid, including a load controller configured to control the load circuits to lower impedance of the power grid (e.g. a microgrid) by connecting one or more loads in response to the microgrid AC voltage rising above a maximum voltage level, and controlling the load circuits to raise microgrid impedance by disconnecting one or more loads in response to the output AC voltage falling below a minimum voltage level.

The present disclosure further teaches a system for voltage regulation of a microgrid and renewable energy storage systems that include load circuits, including: a thermal energy storage medium; heating elements configured to use variable input electrical energy to heat the thermal energy storage medium; load circuits configured to control the connection of the heating elements to a microgrid to relay electrical energy from the microgrid as the input electrical energy to the heating elements; and one or more inverter circuits configured to receive input direct current (DC) voltage levels from one or more variable energy source(s), generate output alternating current (AC) voltage levels on the microgrid based upon the power levels of the input DC voltages, and adjust the output AC voltage levels based on available power levels received from the variable energy source(s). Other loads can also be connected to the microgrid, such as electrode boilers and furnaces, depending on the desired implementation.

A system is disclosed providing for voltage regulation of a microgrid with load circuits coupled to the microgrid, including a load controller configured to control the load circuits to: (a) lower microgrid impedance by connecting one or more loads in response to the microgrid output AC voltage rising above a maximum voltage level; and (b) raise microgrid impedance by disconnecting one or more loads in response to the microgrid output AC voltage falling below a minimum viable voltage level.

A system is further disclosed providing for voltage regulation of a power grid with load circuits couple to the power grid, including means for controlling the load circuits to lower power grid impedance by connecting one or more loads in response to the power grid in response to the power grid AC voltage rising above a maximum voltage level; and means for controlling the load circuits to raise microgrid impedance by disconnecting one or more loads in response to the power grid output AC voltage falling below a minimum viable voltage level.

More generally, the present disclosure teaches a system for voltage regulation of a microgrid and renewable energy storage systems, which can include: means for using electrical energy directly for heating of kilns, ovens, or boilers; storing means for storing thermal energy; heating means for heating the storing means through use of variable input electrical energy; means for connecting or disconnecting the heating means to a microgrid to relay electrical energy from the microgrid as the input electrical energy to the heating means; means for receiving input direct current (DC) voltage levels from one or more variable energy source(s); means for generating output alternating current (AC) voltage levels on the microgrid based upon the power levels of the input DC voltages; and means for adjusting the output AC voltage levels based on available power levels received from the variable energy source(s).

### BRIEF DESCRIPTION OF DRAWINGS

The accompanying drawings are included to provide a further understanding of the present disclosure and are incorporated in and constitute a part of this specification. The drawings illustrate example implementations of the present disclosure and, together with the description, serve to explain the principles of the present disclosure.

In the drawings, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1 to 6 appear in U.S. Pat. No. 11,702,963. FIGS. 7 to 21B include the present further disclosure pertaining to the voltage-controlled power grid regulation in systems powered by variable energy sources.

FIG. 1 illustrates a schematic diagram of the thermal energy storage system architecture according to the example implementations.

FIG. 2 illustrates a schematic diagram of a system according to the example implementations.

FIG. 3 illustrates a schematic diagram of a storage-fired once-through steam generator (OTSG) according to the example implementations.

FIG. 4 illustrates an example view of a system being used as an integrated cogeneration system according to the example implementations.

FIG. 5 illustrates dynamic insulation according to the example implementations.

FIG. 6 provides an isometric view of the thermal storage unit with multiple vents closures open, according to some implementations.

FIG. 7 illustrates a block diagram of an embodiment of a power system according to the present disclosure.

FIG. 8 illustrates a block diagram of an alternative embodiment of a power system according to the present disclosure, which employs the output power of an inverter circuit array.

FIG. 9 illustrates a block diagram of an inverter circuit array in accordance with an example implementation.

FIG. 10 illustrates a block diagram of an embodiment of an inverter circuit array that is configured to use an external control circuit.

FIG. 11A illustrates a block diagram of an embodiment of a thermal storage unit illustrating connection to a power grid.

FIG. 11B illustrates a block diagram of an embodiment of load circuits with loads and thyristors.

FIG. 11C is an activation state diagram showing the operation of the embodiment of FIG. 11B.

FIG. 11D illustrates an example of various load configurations that can be employed by the embodiments herein.

FIG. 12 is a flow diagram depicting an embodiment of a method providing power to a microgrid.

FIG. 13 is a flow diagram depicting an embodiment of another method for providing power to a microgrid.

FIG. 14 is a functional diagram of an inverter in accordance with an example implementation.

FIG. 15 is a table of ranges of input DC voltage levels that are mapped to corresponding power points in accordance with an example implementation.

FIG. 16 illustrates an example state diagram for power grid regulation in accordance with an example implementation.

FIG. 17A is a flow diagram for a load controller configured to interact with load circuits in accordance with an example implementation.

FIG. 17B illustrates another example flow diagram for the load controller, in accordance with an example implementation.

FIG. 18 is a table of load impedances and load power level management information that can be referenced by the controller in accordance with an example implementation.

FIG. 19 is a state diagram for a thermal energy system in accordance with an example implementation.

FIGS. 20A and 20B illustrate an example embodiment involving utilizing multiple inverters to distribute power across multiple power grids from an underlying variable energy source.

FIGS. 21A and 21B illustrate another example embodiment involving multiple inverter circuits for an underlying variable energy source.

### DETAILED DESCRIPTION

Aspects of the example implementations, as disclosed herein, relate to systems, methods, materials, compositions, articles, and improvements for a thermal energy storage system for power generation for various industrial applications.

### I. Thermal Energy Storage System

This Section I of the Summary relates to the disclosure as it appears in U.S. Pat. No. 11,603,776, which is incorporated herein by reference in its entirety as noted above.

U.S. Pat. No. 11,603,776 relates to the field of thermal energy storage and utilization systems and addresses the above-noted problems. A thermal energy storage system is disclosed that stores electrical energy in the form of thermal energy in a charging mode and delivers the stored energy in a discharging mode. The discharging can occur at the same time as charging; i.e., the system may be heated by electrical energy at the same time that it is providing a flow of convectively heated air. The discharged energy is in the form of hot air, hot fluids in general, steam, heated CO₂, heated supercritical CO₂, and/or electrical power generation, and can be supplied to various applications, including industrial uses. The disclosed implementations include efficiently constructed, long-service-life thermal energy storage systems having materials, fabrication, physical shape, and other properties that mitigate damage and deterioration from repeated temperature cycling.

Optionally, heating of the elements of the storage unit may be optimized, so as to store a maximum amount of heat during the charging cycle. Alternatively, heating of elements may be optimized to maximize heating element life, by means including minimizing time at particular heater temperatures, and/or by adjusting peak charging rates and/or peak heating element temperatures. Still other alternatives may balance these competing interests. Specific operations to achieve these optimizations are discussed further below.

Example implementations employ efficient yet economical thermal insulation. Specifically, a dynamic insulation design may be used either by itself or in combination with static primary thermal insulation. The disclosed dynamic insulation techniques provide a controlled flow of air inside the system to restrict dissipation of thermal energy to the outside environment, which results in higher energy storage efficiency.

System Overview as Disclosed in U.S. Pat. No. 11,603,776

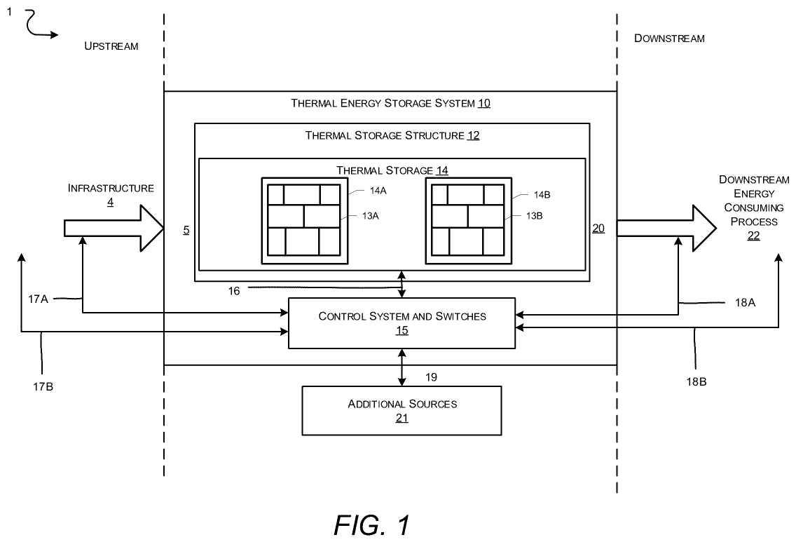

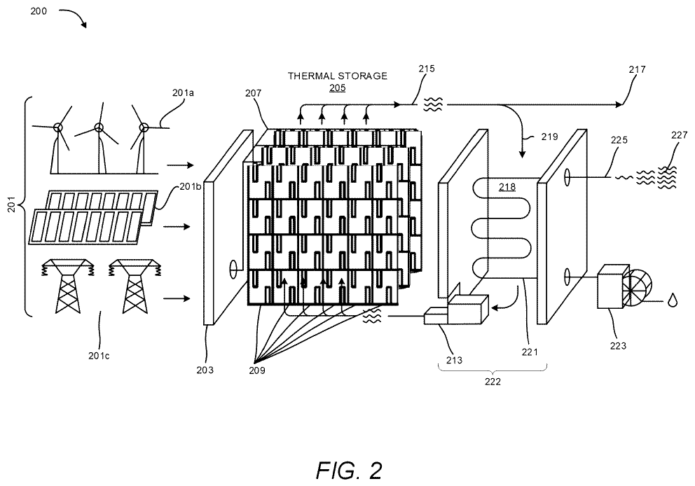

FIG. 1 is a block diagram of a system 1 that includes a thermal energy storage system 10, according to one implementation. In the implementation shown, thermal energy storage system 10 is coupled between an input energy source 2 and a downstream energy-consuming process 22. For ease of reference, components on the input and output sides of system 1 may be described as being “upstream” and “downstream” relative to system 10.

In the depicted implementation, thermal energy storage system 10 is coupled to input energy source 2, which may include one or more sources of electrical energy. Source 2 may be renewable, such as photovoltaic (PV) cell or solar, wind, geothermal, etc. Source 2 may also be another source, such as nuclear, natural gas, coal, biomass, or other. Source 2 may also include a combination of renewable and other sources. In this implementation, source 2 is provided to thermal energy storage system 10 via infrastructure 4, which may include one or more electrical conductors, commutation equipment, etc. In some implementations, infrastructure 4 may include circuitry configured to transport electricity over long distances; alternatively, in implementations in which input energy source 2 is located in the immediate vicinity of thermal energy storage system 10, infrastructure 4 may be greatly simplified. Ultimately, infrastructure 4 delivers energy to input 5 of thermal energy storage system 10 in the form of electricity.

The electrical energy delivered by infrastructure 4 is input to thermal storage structure 12 within system 10 through switchgear, protective apparatus and active switches controlled by control system 15. Thermal storage structure 12 includes thermal storage 14, which in turn includes one more assemblages (e.g., 14A, 14B) of solid storage media (e.g., 13A, 13B) configured to store thermal energy. These assemblages are variously referred to throughout this disclosure as “stacks,” “arrays,” and the like. These terms are intended to be generic and not connote any particular orientation in space, etc. In general, an array can include any material that is suitable for storing thermal energy and can be oriented in any given orientation (e.g., vertically, horizontally, etc.). Likewise, the solid storage media within the assemblages may variously be referred to as thermal storage blocks, bricks, etc. In implementations with multiple arrays, the arrays may be thermally isolated from one another and are separately controllable, meaning that they are capable of being charged or discharged independently from one another. This arrangement provides maximum flexibility, permitting multiple arrays to be charged at the same time, multiple arrays to be charged at different times or at different rates, one array to be discharged while the other array remains charged, etc.

Thermal storage 14 is configured to receive electrical energy as an input. The received electrical energy may be provided to thermal storage 14 via resistive heating elements that are heated by electrical energy and emit heat, primarily as electromagnetic radiation in the infrared and visible spectrum. During a charging mode of thermal storage 14, the electrical energy is released as heat from the resistive heating elements, transferred principally by radiation emitted both by the heating elements and by hotter solid storage media, and absorbed and stored in solid media within storage 14. When an array within thermal storage 14 is in a discharging mode, the heat is discharged from thermal storage structure 12 as output 20. As will be described, output 20 may take various forms, including a fluid such as hot air. (References to the use of “air” and “gases” within the present disclosure may be understood to refer more generally to a “fluid.”) The hot air may be provided directly to a downstream energy consuming process 22 (e.g., an industrial application), or it may be passed through a steam generator (not shown) to generate steam for process 22.

Additionally, thermal energy storage system 10 includes a control system 15. Control system 15, in various implementations, is configured to control thermal storage 14, including through setting operational parameters (e.g., discharge rate), controlling fluid flows, controlling the actuation of electromechanical or semiconductor electrical switching devices, etc. The interface 16 between control system 15 and thermal storage structure 12 (and, in particular thermal storage 14) is indicated in FIG. 1. Control system 15 may be implemented as a combination of hardware and software in various embodiments.

Control system 15 may also interface with various entities outside thermal energy storage system 10. For example, control system 15 may communicate with input energy source 2 via an input communication interface 17B. For example, interface 17B may allow control system 15 to receive information relating to energy generation conditions at input energy source 2. In the implementation in which input energy source 2 is a photovoltaic array, this information may include, for example, current weather conditions at the site of source 2, as well as other information available to any upstream control systems, sensors, etc. Interface 17B may also be used to send information to components or equipment associated with source 2.

Similarly, control system 15 may communicate with infrastructure 4 via an infrastructure communication interface 17A. In a manner similar to that explained above, interface 17A may be used to provide infrastructure information to control system 15, such as current or forecast VRE availability, grid demand, infrastructure conditions, maintenance, emergency information, etc. Conversely, communication interface 17A may also be used by control system 15 to send information to components or equipment within infrastructure 4. For example, the information may include control signals transmitted from the control system 15, that controls valves or other structures in the thermal storage structure 12 to move between an open position and a closed position, or to control electrical or electronic switches connected to heaters in the thermal storage 14. Control system 15 uses information from communication interface 17A in determining control actions, and control actions may adjust closing or firing of switches in a manner to optimize the use of currently available electric power and maintain the voltage and current flows within infrastructure 4 within chosen limits.

Control system 15 may also communicate downstream using interfaces 18A and/or 18B. Interface 18A may be used to communicate information to any output transmission structure (e.g., a steam transmission line), while interface 18B may be used to communicate with downstream process 22. For example, information provided over interfaces 18A and 18B may include temperature, industrial application demand, current or future expected conditions of the output or industrial applications, etc. Control system 15 may control the input, heat storage, and output of thermal storage structure based on a variety of information. As with interfaces 17A and 17B, communication over interfaces 18A and 18B may be bidirectional—for example, system 10 may indicate available capacity to downstream process 22. Still further, control system 15 may also communicate with any other relevant data sources (indicated by reference numeral 21 in FIG. 1) via additional communication interface 19. Additional data sources 21 are broadly intended to encompass any other data source not maintained by either the upstream or downstream sites. For example, sources 21 might include third-party forecast information, data stored in a cloud data system, etc.

Thermal energy storage system 10 is configured to efficiently store thermal energy generated from input energy source 2 and deliver output energy in various forms to a downstream process 22. In various implementations, input energy source 2 may be from renewable energy and downstream process 22 may be an industrial application that requires an input such as steam or hot air. Through various techniques, including arrays of thermal storage blocks that use radiant heat transfer to efficiently storage energy and a lead-lag discharge paradigm that leads to desirable thermal properties such as the reduction of temperature nonuniformities within thermal storage 14, system 10 may advantageously provide a continuous (or near-continuous) flow of output energy based on an intermittently available source. The use of such a system has the potential to reduce the reliance of industrial applications on fossil fuels.

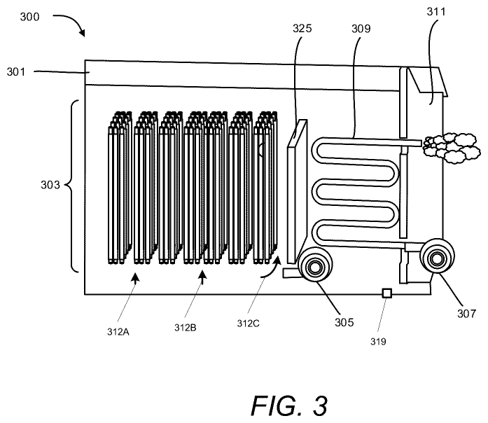

FIG. 2 provides a schematic view of one implementation of a system 200 for storing thermal energy, and further illustrates components and concepts just described with respect to FIG. 1. As shown, one or more energy sources 201 provide input electricity. For example, and as noted above, renewable sources such as wind energy from wind turbines 201a, solar energy from photovoltaic cells 201b, or other energy sources may provide electricity that is variable in availability or price because the conditions for generating the electricity are varied. For example, in the case of wind turbine 201a, the strength, duration and variance of the wind, as well as other weather conditions causes the amount of energy that is produced to vary over time (e.g., affects the rate of rotation of the rotor blades of the wind turbine). Similarly, the amount of energy generated by photovoltaic cells 201b also varies over time, depending on factors such as time of day, length of day due to the time of year, level of cloud cover due to weather conditions, temperature, other ambient conditions, etc. Further, the input electricity may be received from the existing power grid 201c, which may in turn vary based on factors such as pricing, customer demand, maintenance, and emergency requirements.

The electricity generated by source 201 is provided to the thermal storage structure within the thermal energy storage system. In FIG. 2, the passage of electricity into the thermal storage structure is represented by wall 203. The input electrical energy is converted to heat within thermal storage 205 via resistive heating elements 207 controlled by switches (not shown). Heating elements 207 provide heat to solid storage media 209. Thermal storage components (sometimes called “bricks”) within thermal storage 205 are arranged to form embedded radiative chambers. FIG. 2 illustrates that multiple thermal storage arrays 209 may be present within system 200. These arrays may be thermally isolated from one another and may be separately controllable. FIG. 2 is merely intended to provide a conceptual representation of how thermal storage 205 might be implemented—one such implementation might, for example, include only two arrays, or might include six arrays, or ten arrays, or more.

In the depicted implementation, a blower 213 drives air or other fluid to thermal storage 205 such that the air is eventually received at a lower portion of each of the arrays 209. The air flows upward through the channels and chambers formed by bricks in each of the arrays 209, with flow controlled by louvers. By the release of heat energy from the resistive heating elements 207, heat is radiatively transferred to arrays 209 of bricks during a charging mode. Relatively hotter brick surfaces reradiate absorbed energy (which may be referred to as a radiative “echo”) and participate in heating cooler surfaces. During a discharging mode, the heat stored in arrays 209 is output, as indicated at 215.

Once the heat has been output in the form of a fluid such as hot air, the fluid may be provided for one or more downstream applications. For example, hot air may be used directly in an industrial process that is configured to receive the hot air, as shown at 217. Further, hot air may be provided as a stream 219 to a heat exchanger 218 of a steam generator 222, and thereby heats a pressurized fluid such as air, water, CO₂ or other gas. In the example shown, as the hot air stream 219 passes over a line 221 that provides the water from the pump 223 as an input, the water is heated and steam is generated as an output 225, which may be provided to an industrial application as shown at 227.

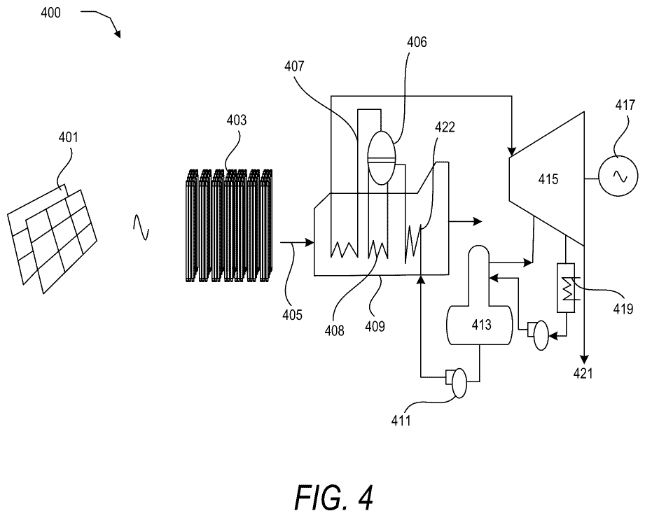

A thermal storage structure such as that depicted in FIGS. 1-2 may also include output equipment configured to produce steam for use in a downstream application. FIG. 3, for example, depicts a block diagram of an implementation of a thermal storage structure 300 that includes a storage-fired once-through steam generator (OTSG). An OTSG is a type of heat recovery stream generator (HRSG), which is a heat exchanger that accepts hot air from a storage unit, returns cooler air, and heats an external process fluid. The depicted OTSG is configured to use thermal energy stored in structure 300 to generate steam at output 311.

As has been described, thermal storage structure 300 includes outer structure 301 such walls, a roof, as well as thermal storage 303 in a first section of the structure. The OTSG is located in a second section of the structure, which is separated from the first section by thermal barrier 325. During a charging mode, thermal energy is stored in thermal storage 303. During a discharging mode, the thermal energy stored in thermal storage 303 receives a fluid flow (e.g., air) by way of a blower 305. These fluid flows may be generated from fluid entering structure 300 via an inlet valve 319 and include a first fluid flow 312A (which may be directed to a first stack within thermal storage 303) and a second fluid flow 312B (which may be directed to a second stack within thermal storage 303).

As the air or other fluid directed by blower 305 flows through the thermal storage 303 from the lower portion to the upper portion, it is heated and is eventually output at the upper portion of thermal storage 303. The heated air, which may be mixed at some times with a bypass fluid flow 312C that has not passed through thermal storage 302, is passed over a conduit 309 through which flows water, or another fluid pumped by the water pump 307. As the hot air heats up the water in the conduit, steam is generated at 311. The cooled air that has crossed the conduit (and transferred heat to the water flowing through it) is then fed back into the brick heat storage 303 by blower 305. As explained below, the control system can be configured to control attributes of the steam, including steam quality, or fraction of the steam in the vapor phase, and flow rate.

As shown in FIG. 3, an OTSG does not include a recirculating drum boiler. Properties of steam produced by an OTSG are generally more difficult to control than those of steam produced by a more traditional HRSG with a drum, or reservoir. The steam drum in such an HRSG acts as a phase separator for the steam being produced in one or more heated tubes recirculating the water; water collects at the bottom of the reservoir while the steam rises to the top. Saturated steam (having a steam quality of 100%) can be collected from the top of the drum and can be run through an additional heated tube structure to superheat it and further assure high steam quality. Drum-type HRSGs are widely used for power plants and other applications in which the water circulating through the steam generator is highly purified and stays clean in a closed system. For applications in which the water has significant mineral content, however, mineral deposits form in the drum and tubes and tend to clog the system, making a recirculating drum design infeasible.

For applications using water with a higher mineral content, an OTSG may be a better option. One such application is oil extraction, in which feed water for a steam generator may be reclaimed from a water/oil mixture produced by a well. Even after filtering and softening, such water may have condensed solid concentrations on the order of 10,000 ppm or higher. The lack of recirculation in an OTSG enables operation in a mode to reduce mineral deposit formation; however, an OTSG needs to be operated carefully in some implementations to avoid mineral deposits in the OTSG water conduit. For example, having some fraction of water droplets present in the steam as it travels through the OTSG conduit may be required to prevent mineral deposits by retaining the minerals in solution in the water droplets. This consideration suggests that the steam quality (vapor fraction) of steam within the conduit must be maintained below a specified level. On the other hand, a high steam quality at the output of the OTSG may be important for the process employing the steam. Therefore, it is advantageous for a steam generator powered by VRE through TES to maintain close tolerances on outlet steam quality. There is a sensitive interplay among variables such as input water temperature, input water flow rate and heat input, which must be managed to achieve a specified steam quality of output steam while avoiding damage to the OTSG.

Implementations of the thermal energy storage system disclosed herein provide a controlled and specified source of heat to an OTSG. The controlled temperature and flow rate available from the thermal energy storage system allows effective feed-forward and feedback control of the steam quality of the OTSG output. In one implementation, feed-forward control includes using a target steam delivery rate and steam quality value, along with measured water temperature at the input to the water conduit of the OTSG, to determine a heat delivery rate required by the thermal energy storage system for achieving the target values. In this implementation, the control system can provide a control signal to command the thermal storage structure to deliver the flowing gas across the OTSG at the determined rate. In one implementation, a thermal energy storage system integrated with an OTSG includes instrumentation for measurement of the input water temperature to the OTSG.

In one implementation, feedback control includes measuring a steam quality value for the steam produced at the outlet of the OTSG, and a controller using that value to adjust the operation of the system to return the steam quality to a desired value. Obtaining the outlet steam quality value may include separating the steam into its liquid and vapor phases and independently monitoring the heat of the phases to determine the vapor phase fraction. Alternatively, obtaining the outlet steam quality value may include measuring the pressure and velocity of the outlet steam flow and the pressure and velocity of the inlet water flow, and using the relationship between values to calculate an approximation of the steam quality. Based on the steam quality value, a flow rate of the outlet fluid delivered by the thermal storage to the OTSG may be adjusted to achieve or maintain the target steam quality. In one implementation, the flow rate of the outlet fluid is adjusted by providing a feedback signal to a controllable element of the thermal storage system. The controllable element may be an element used in moving fluid through the storage medium, such as a blower or other fluid moving device, a louver, or a valve.

The steam quality measurement of the outlet taken in real time may be used as feedback by the control system to determine the desired rate of heat delivery to the OTSG. To accomplish this, an implementation of a thermal energy storage system integrated with an OTSG may include instruments to measure inlet water velocity and outlet steam flow velocity, and, optionally, a separator along with instruments for providing separate measurements of the liquid and vapor heat values. In some implementations, the tubing in an OTSG is arranged such that the tubing closest to the water inlet is positioned in the lowest temperature portion of the airflow, and that the tubing closest to the steam exit is positioned in the highest temperature portion of the airflow. In some implementations of the present innovations, the OTSG may instead be configured such that the highest steam quality tubes (closest to the steam outlet) are positioned at some point midway through the tubing arrangement, so as to enable higher inlet fluid temperatures from the TSU to the OTSG while mitigating scale formation within the tubes and overheating of the tubes, while maintaining proper steam quality. The specified flow parameters of the heated fluid produced by thermal energy storage systems as disclosed herein may in some implementations allow precise modeling of heat transfer as a function of position along the conduit. Such modeling may allow specific design of conduit geometries to achieve a specified steam quality profile along the conduit.

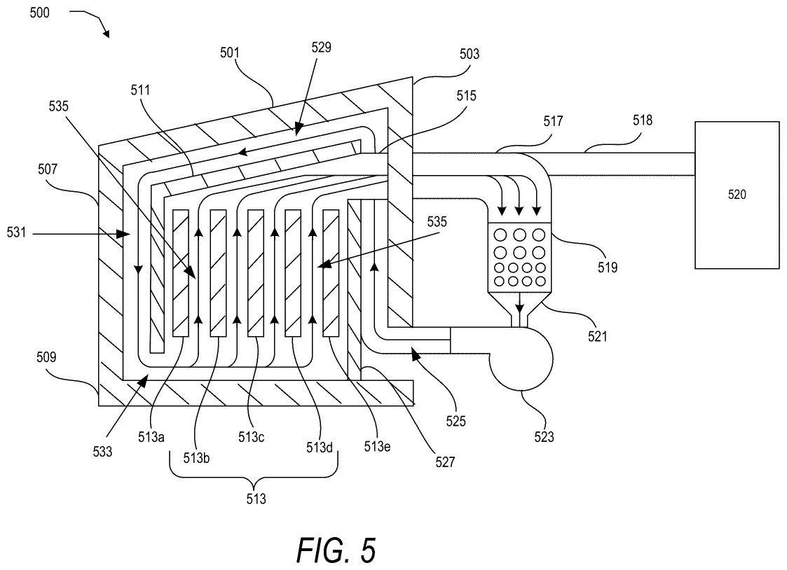

As shown in FIG. 4, the output of the thermal energy storage system may be used for an integrated cogeneration system 400. As previously explained, an energy source 401 provides electrical energy that is stored as heat in the heat storage 403 of the TSU. During discharge, the heated air is output at 405. As shown in FIG. 4, lines containing a fluid, in this case water, are pumped into a drum 406 of an HRSG 409 via a preheating section of tubing 422. In this implementation, HRSG 409 is a recirculating drum type steam generator, including a drum or boiler 406 and a recirculating evaporator section 408. The output steam passes through line 407 to a superheater coil, and is then provided to a turbine at 415, which generates electricity at 417. As an output, the remaining steam 421 may be expelled to be used as a heat source for a process or condensed at 419 and optionally passed through to a deaeration unit 413 and delivered to pump 411 in order to perform subsequent steam generation.

Certain industrial applications may be particularly well-suited for cogeneration. For example, some applications use higher temperature heat in a first system, such as to convert the heat to mechanical motion as in the case of a turbine, and lower-temperature heat discharged by the first system for a second purpose, in a cascading manner; or an inverse temperature cascade may be employed. One example involves a steam generator that makes high-pressure steam to drive a steam turbine that extracts energy from the steam, and low-pressure steam that is used in a process, such as an ethanol refinery, to drive distillation and electric power to run pumps. Still another example involves a thermal energy storage system in which hot gas is output to a turbine, and the heat of the turbine outlet gas is used to preheat inlet water to a boiler for processing heat in another steam generator (e.g., for use in an oilfield industrial application). In one application, cogeneration involves the use of hot gas at e.g., 840° C. to power or co-power hydrogen electrolysis, and the lower temperature output gas of the hydrogen electrolyzer, which may be at about 640° C., is delivered alone or in combination with higher-temperature heat from a TSU to a steam generator or a turbine for a second use. In another application, cogeneration involves the supply of heated gas at a first temperature e.g., 640° C. to enable the operation of a fuel cell, and the waste heat from the fuel cell which may be above 800° C. is delivered to a steam generator or a turbine for a second use, either alone or in combination with other heat supplied from a TSU.

A cogeneration system may include a heat exchange apparatus that receives the discharged output of the thermal storage unit and generates steam. Alternately, the system may heat another fluid such as supercritical carbon dioxide by circulating high-temperature air from the system through a series of pipes carrying a fluid, such as water or CO₂, (which transfers heat from the high-temperature air to the pipes and the fluid), and then recirculating the cooled air back as an input to the thermal storage structure. This heat exchange apparatus is an HRSG, and in one implementation is integrated into a section of the housing that is separated from the thermal storage.

The HRSG may be physically contained within the thermal storage structure or may be packaged in a separate structure with ducts conveying air to and from the HRSG. The HRSG can include a conduit at least partially disposed within the second section of the housing. In one implementation, the conduit can be made of thermally conductive material and be arranged so that fluid flows in a “once-through” configuration in a sequence of tubes, entering as lower-temperature fluid and exiting as higher temperature, possibly partially evaporated, two-phase flow. As noted above, once-through flow is beneficial, for example, in processing feedwater with substantial dissolved mineral contaminants to prevent accumulation and precipitation within the conduits.

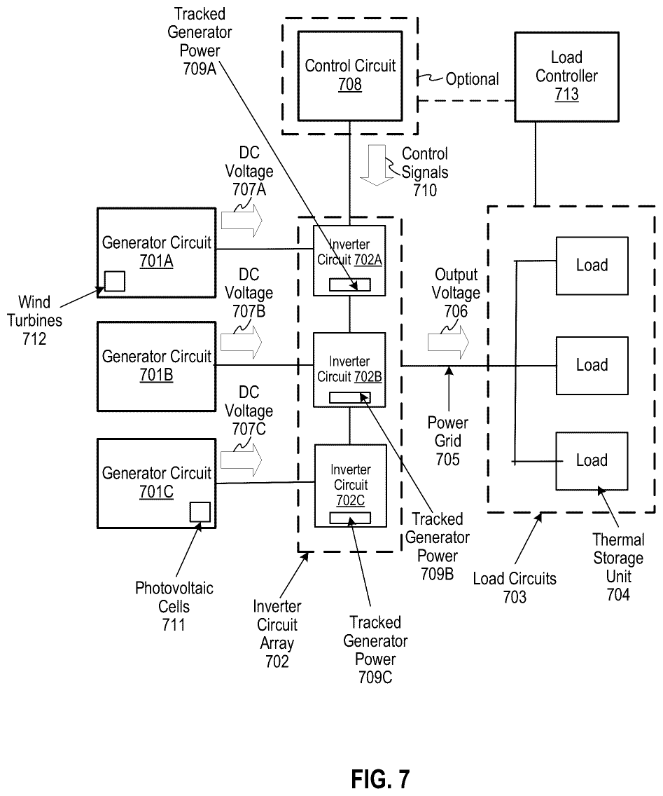

In an OTSG implementation, a first end of the conduit can be fluidically coupled to a water source. The system may provide for inflow of the fluids from the water source into a first end of the conduit and enable outflow of the received fluid or steam from a second end of the conduit. The system can include one or more pumps configured to facilitate inflow and outflow of the fluid through the conduit. The system can include a set of valves configured to facilitate controlled outflow of steam from the second end of the conduit to a second location for one or more industrial applications or electrical power generation. As shown in FIG. 6, an HRSG may also be organized as a recirculating drum-type boiler with an economizer and optional superheater, for the delivery of saturated or superheated steam.

The output of the steam generator may be provided for one or more industrial uses. For example, steam may be provided to a turbine generator that outputs electricity for use as retail local power. The control system may receive information associated with local power demands, and determine the amount of steam to provide to the turbine, so that local power demands can be met.

In addition to the generation of electricity, the output of the thermal storage structure may be used for industrial applications as explained below. Some of these applications may include, but are not limited to, electrolyzers, fuel cells, gas generation units such as hydrogen, carbon capture, manufacture of materials such as cement, calcining applications, as well as others. More details of these industrial applications are provided below.

### Dynamic Insulation

It is generally beneficial for a thermal storage structure to minimize its total energy losses via effective insulation, and to minimize its cost of insulation. Some insulation materials are tolerant of higher temperatures than others. Higher-temperature tolerant materials tend to be more costly.

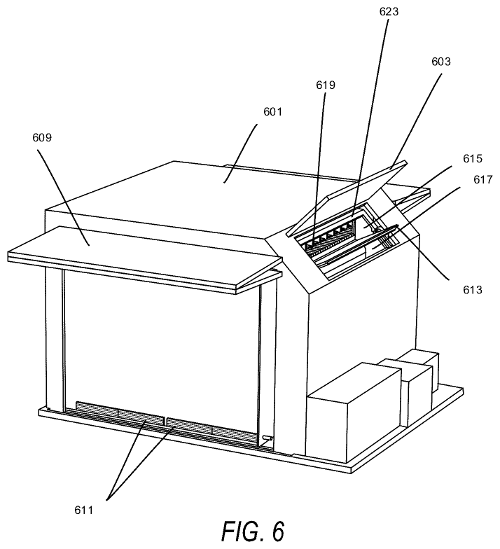

FIG. 5 provides a schematic section illustration 500 of an implementation of dynamic insulation. The outer container includes roof 501, walls 503, 507 and a foundation 509. Within the outer container, a layer of insulation 511 is provided between the outer container and columns of bricks in stack 513, the columns being represented as 513a, 513b, 513c, 513d and 513e. The heated fluid that is discharged from the upper portion of the columns of bricks 513a, 513b, 513c, 513d and 513e exits by way of an output 515, which is connected to a duct 517. Duct 517 provides the heated fluid as an input to a steam generator 519. Once the heated fluid has passed through steam generator 519, some of its heat is transferred to the water in the steam generator and the stream of fluid is cooler than when exiting the steam generator. Further, the heated fluid may be used directly in an industrial process 520 that is configured to receive the heated fluid, as shown at 518. Cooler recycled fluid exits a bottom portion 521 of the steam generator 519. An air blower 523 receives the cooler fluid, and provides the cooler fluid, via a passage 525 defined between the walls 503 and insulation 527 positioned adjacent the stack 513, through an upper air passage 529 defined between the insulation 511 and the roof 501, down through side passages 531 defined on one or more sides of the stack 513 and the insulation 511, and thence down to a passage 533 directly below the stack 513.

The air in passages 525, 529, 531 and 533 acts as an insulating layer between (a) the insulations 511 and 527 surrounding the stack 513, and (b) the roof 501, walls 503, 507 and foundation 509. Thus, heat from the stack 513 is prevented from overheating the roof 501, walls 503, 507 and foundation 509. At the same time, the air flowing through those passages 525, 529, 531 and 533 carries by convection heat that may penetrate the insulations 511 and/or 517 into air flow passages 535 of the stack 513, thus preheating the air, which is then heated by passage through the air flow passages 535.

The columns of bricks 513a, 513b, 513c, 513d and 513e and the air passages 535 are shown schematically in FIG. 5. The physical structure of the stacks and air flow passages therethrough in embodiments described herein is more complex, leading to advantages.

In some implementations, to reduce or minimize the total energy loss, the layer of insulation 511 is a high-temperature primary insulation that surrounds the columns 513a, 513b, 513c, 513d and 513e within the housing. Outer layers of lower-cost insulation may also be provided. The primary insulation may be made of thermally insulating materials selected from any combination of refractory bricks, alumina fiber, ceramic fiber, and fiberglass or any other material that might be apparent to a person of ordinary skill in the art. The amount of insulation required to achieve low losses may be large, given the high temperature differences between the storage media and the environment. To reduce energy losses and insulation costs, conduits are arranged to direct returning, cooler fluid from the HRSG along the outside of a primary insulation layer before it flows into the storage core for reheating.

The cooler plenum, including passages 525, 529, 531 and 533, is insulated from the outside environment, but total temperature differences between the cooler plenum and the outside environment are reduced, which in turn reduces thermal losses. This technique, known as “dynamic insulation,” uses the cooler returning fluid, as described above, to recapture heat which passes through the primary insulation, preheating the cooler air before it flows into the stacks of the storage unit. This approach further serves to maintain design temperatures within the foundation and supports of the thermal storage structure. Requirements for foundation cooling in existing designs (e.g., for molten salt) involve expensive dedicated blowers and generators—requirements avoided by implementations according to the present teaching.

The materials of construction and the ground below the storage unit may not be able to tolerate high temperatures, and in the present system active cooling—aided by the unassisted flowing heat exchange fluid in the case of power failure—can maintain temperatures within design limits.

A portion of the fluid returning from the HRSG may be directed through conduits such as element 521 located within the supports and foundation elements, cooling them and delivering the captured heat back to the input of the storage unit stacks as preheated fluid. The dynamic insulation may be provided by arranging the bricks 513a, 513b, 513c, 513d and 513e within the housing so that the bricks 513a, 513b, 513c, 513d and 513e are not in contact with the outer surface 501, 503, 507 of the housing, and are thus thermally isolated from the housing by the primary insulation formed by the layer of cool fluid. The bricks 513a, 513b, 513c, 513d and 513e may be positioned at an elevated height from the bottom of the housing, using a platform made of thermally insulating material.

During unit operation, a controlled flow of relatively cool fluid is provided by the fluid blowing units 523, to a region (including passages 525, 529, 531 and 533) between the housing and the primary insulation (which may be located on an interior or exterior of an inner enclosure for one or more thermal storage assemblages), to create the dynamic thermal insulation between the housing and the bricks, which restricts the dissipation of thermal energy being generated by the heating elements and/or stored by the bricks into the outside environment or the housing, and preheats the fluid. As a result, the controlled flow of cold fluid by the fluid blowing units of the system may facilitate controlled transfer of thermal energy from the bricks to the conduit, and also facilitates dynamic thermal insulation, thereby making the system efficient and economical.

In another example implementation, the buoyancy of fluid can enable an unassisted flow of the cold fluid around the bricks between the housing and the primary insulator 511 such that the cold fluid may provide dynamic insulation passively, even when the fluid blowing units 523 fail to operate in case of power or mechanical failure, thereby maintaining the temperature of the system within predefined safety limits, to achieve intrinsic safety. The opening of vents, ports, or louvres (not shown) may establish passive buoyancy-driven flow to maintain such flow, including cooling for supports and foundation cooling, during such power outages or unit failures, without the need for active equipment.

In the above-described fluid flow, the fluid flows to an upper portion of the unit, down the walls and into the inlet of the stacking, depending on the overall surface area to volume ratio, which is in turn dependent on the overall unit size, the flow path of the dynamic insulation may be changed. For example, in the case of smaller units that have greater surface area as compared with the volume, the amount of fluid flowing through the stack relative to the area may utilize a flow pattern that includes a series of serpentine channels, such that the fluid flows on the outside, moves down the wall, up the wall, and down the wall again before flowing into the inlet. Other channelization patterns may also be used.

Additionally, the pressure difference between the return fluid in the insulation layer and the fluid in the stacks may be maintained such that the dynamic insulation layer has a substantially higher pressure than the pressure in the stacks themselves. Thus, if there is a leak between the stacks and the insulation, the return fluid at the higher pressure may be forced into the leak or the cracks, rather than the fluid within the stacks leaking out into the dynamic insulation layer. Accordingly, in the event of a leak in the stacks, the very hot fluid of the stacks may not escape outside of the unit, but instead the return fluid may push into the stacks, until the pressure between the dynamic insulation layer in the stacks equalizes. Pressure sensors may be located on either side of the blower that provide relative and absolute pressure information. With such a configuration, a pressure drop within the system may be detected, which can be used to locate the leak.

Earlier systems that store high temperature sensible heat in rocks and molten salts have required continuous active means of cooling foundations, and in some implementations continuous active means of heating system elements to prevent damage to the storage system; thus, continuous active power and backup power supply systems are required. A system as described herein does not require an external energy supply to maintain the safety of the unit. Instead, as described below, the present disclosure provides a thermal storage structure that provides for thermally induced flows that passively cools key elements when equipment, power, or water fails. This also reduces the need for fans or other cooling elements inside the thermal storage structure.

### Forecast-Based System Control

As noted above, forecast information such as weather predictions may be used by a control system to reduce wear and degradation of system components. Another goal of forecast-based control is to ensure adequate thermal energy production from the thermal energy storage system to the load or application system. Actions that may be taken in view of forecast information include, for example, adjustments to operating parameters of the thermal energy storage system itself, adjustments to an amount of input energy coming into the thermal energy storage system, and actions or adjustments associated with a load system receiving an output of the thermal energy storage system.

Weather forecasting information can come from one or more of multiple sources. One source is a weather station at a site located with the generation of electrical energy, such as a solar array or photovoltaic array, or wind turbines. The weather station may be integrated with a power generation facility, and may be operationally used for control decisions of that facility, such as for detection of icing on wind turbines. Another source is weather information from sources covering a wider area, such as radar or other weather stations, which may be fed into databases accessible by the control system of the thermal energy storage system. Weather information covering a broader geography may be advantageous in providing more advanced notice of changes in condition, as compared to the point source information from a weather station located at the power source. Still another possible source of weather information is virtual or simulated weather forecast information. In general, machine learning methods can be used to train the system, taking into account such data and modifying behavior of the system.

As an example, historical information associated with a power curve of an energy source may be used as a predictive tool, taking into account actual conditions, to provide forecasting of power availability and adjust control of the thermal energy storage system, both as to the amount of energy available to charge the units and the amount of discharge heat output available. For example, the power curve information may be matched with actual data to show that when the power output of a photovoltaic array is decreasing, it may be indicative of a cloud passing over one or more parts of the array, or cloudy weather generally over the region associated with the array.

Forecast-related information is used to improve the storage and generation of heat at the thermal energy storage system in view of changing conditions. For example, a forecast may assist in determining the amount of heat that must be stored and the rate at which heat must be discharged in order to provide a desired output to an industrial application—for instance, in the case of providing heat to a steam generator, to ensure a consistent quality and amount of steam, and to ensure that the steam generator does not have to shut down. The controller may adjust the current and future output of heat in response to current or forecast reductions in the availability of charging electricity, so as to ensure across a period of future time that the state of charge of the storage unit does not reduce so that heat output must be stopped. By adjusting the continuous operation of a steam generator to a lower rate in response to a forecasted reduction of available input energy, the unit may operate continuously. The avoidance of shutdowns and later restarts is an advantageous feature: shutting down and restarting a steam generator is a time-consuming process that is costly and wasteful of energy, and potentially exposes personnel and industrial facilities to safety risks.

The forecast, in some cases, may be indicative of an expected lower electricity input or some other change in electricity input pattern to the thermal energy storage system. Accordingly, the control system may determine, based on the input forecast information, that the amount of energy that would be required by the thermal energy storage system to generate the heat necessary to meet the demands of the steam generator or other industrial application is lower than the amount of energy expected to be available. In one implementation, making this determination involves considering any adjustments to operation of the thermal energy storage system that may increase the amount of heat it can produce. For example, one adjustment that may increase an amount of heat produced by the system is to run the heating elements in a thermal storage assemblage at a higher power than usual during periods of input supply availability, in order to obtain a higher temperature of the assemblage and greater amount of thermal energy stored. Such “overcharging” or “supercharging” of an assemblage, as discussed further below, may in some implementations allow sufficient output heat to be produced through a period of lowered input energy supply. Overcharging may increase stresses on the thermal storage medium and heater elements of the system, thus increasing the need for maintenance and the risk of equipment failure.

As an alternative to operational adjustments for the thermal energy storage system, or in embodiments for which such adjustments are not expected to make up for a forecasted shortfall of input energy, action on either the source side or the load side of the thermal energy storage system may be initiated by the control system. On the input side, for example, the forecast difference between predicted and needed input power may be used to provide a determination, or decision-support, with respect to sourcing input electrical energy from other sources during an upcoming time period, to provide the forecasted difference. For example, if the forecasting system determines that the amount of electrical energy to be provided from a photovoltaic array will be 70% of the expected amount needed over a given period of time, e.g., due to a forecast of cloudy weather, the control system may effectuate connection to an alternative input source of electrical energy, such as wind turbine, natural gas or other source, such that the thermal energy storage system receives 100% of the expected amount of energy. In an implementation of a thermal energy storage system having an electrical grid connection available as an alternate input power source, the control system may effectuate connection to the grid in response to a forecast of an input power shortfall.

In a particular implementation, forecast data may be used to determine desired output rates for a certain number of hours or days ahead, presenting to an operator signals and information relating to expected operational adjustments to achieve those output rates, and providing the operator with a mechanism to implement the output rates as determined by the system, or alternatively to modify or override those output rates. This may be as simple as a “click to accept” feedback option provided to the operator, a dead-man's switch that automatically implements the determined output rates unless overridden, and/or more detailed options of control parameters for the system.

### II. Heat Transport in TSU: Bricks and Heating Elements

A. Problems solved by one or more disclosed embodiments

Traditional approaches to the formation of energy storage cells may have various problems and disadvantages. For example, traditional approaches may not provide for uniform heating of the thermal energy storage cells. Instead, they may use structures that create uneven heating, such as hot spots and cold spots. Non-uniform heating may reduce the efficiency of an energy storage system, lead to earlier equipment failure, cause safety problems, etc. Further, traditional approaches may suffer from wear and tear on thermal energy storage cells. For example, stresses such as mechanical and thermal stress may cause deterioration of performance, as well as destabilization of the material, such as cracking of the bricks.

B. Example Solutions Disclosed Herein

In some implementations, thermal storage blocks (e.g., bricks) have various features that facilitate more even distribution. As one example, blocks may be formed and positioned to define fluid flow pathways with chambers that are open to heating elements to receive radiative energy. Therefore, a given fluid flow pathway (e.g., oriented vertically from the top to bottom of a stack) may include two types of openings: radiation chambers that are open to a channel for a heating element and fluid flow openings (e.g., fluid flow slots) that are not open to the channel. The radiation chambers may receive infrared radiation from heater elements, which, in conjunction with conductive heating by the heater elements may provide more uniform heating of an assemblage of thermal storage blocks, relative to traditional implementations. The fluid flow openings may receive a small amount of radiative energy indirectly via the chambers, but are not directly open to the heating element. The stack of bricks may be used alone or in combination with other stacks of bricks to form the thermal storage unit, and one or more thermal storage units may be used together in the thermal energy storage system. As the fluid blower circulates the fluid through the structure during charge and discharge as explained above, a thermocline may be formed in a substantially vertical direction. Further, the fluid movement system may direct relatively cooler fluid for insulative purposes, e.g., along the insulated walls and roof of the structure. Finally, a venting system may allow for controlled cooling for maintenance or in the event of power loss, water loss, blower failure, etc., which may advantageously improve safety relative to traditional techniques.

Designs according to the present disclosure combine several key innovations, which together address these challenges and enable a cost-effective, safe, reliable high-temperature thermal energy storage system to be built and operated. A carefully structured solid media system according to the present teaching incorporates structured airflow passages which accomplish effective thermocline discharge; repeated mixing chambers along the direction of air flow which mitigate the thermal effects of any localized air channel blockages or nonuniformities; effective shielding of thermal radiation from propagating in the vertical direction; and a radiation chamber structure which uniformly and rapidly heats brick material with high heater power loading, low and uniform exposed surface temperature, and long-distance heat transfer within the storage media array via multi-step thermal radiation.

Innovative structures according to the present disclosure may comprise an array of bricks that form chambers. The bricks have structured air passages, such that in the vertical direction air flows upwards in a succession of open chambers and small air passages. In some embodiments, the array of bricks with internal air passages is organized in a structure such that the outer surface of each brick within the TSU core forms a wall of a chamber in which it is exposed to radiation from other brick surfaces, as well as radiation originating from an electrical heater.

The chamber structure is created by alternating brick materials into a checkerboard-type pattern, in which each brick is surrounded on all sides by open chambers, and each open chamber has adjacent bricks as its walls. In addition, horizontal parallel passages are provided that pass through multiple chambers. Electrical heating elements that extend horizontally through the array are installed in these passages. An individual heating element it may be exposed along its length to the interior spaces of multiple chambers. Each brick within such a checkerboard structure is exposed to open chambers on all sides. Accordingly, during charging, radiant energy from multiple heating elements heats all outer surfaces of each brick, contributing to the rapid and even heating of the brick, and reducing reliance on conductive heat transfer within the brick by limiting the internal dimensions of the brick.

The radiation chamber structure provides a key advance in the design and production of effective thermal energy storage systems that are charged by electrical energy. The large surface area, which is radiatively exposed to heaters, causes the average temperature of the large surface to determine the radiation balance and thus the surface temperature of the heater. This intrinsic uniformity enables a high wattage per unit area of heater without the potential of localized overheating. And exposed brick surfaces are larger per unit of mass than in prior systems, meaning that incoming wattage per unit area is correspondingly smaller, and consequently thermal stresses due to brick internal temperature differences are lower. And critically, re-radiation of energy—radiation by hotter brick surfaces that is absorbed by cooler brick surfaces—reduces by orders of magnitude the variations in surface temperature, and consequently reduces thermal stresses in brick materials exposed to radiant heat. Thus, the radiation chamber design effectively enables heat to be delivered relatively uniformly to a large horizontally oriented surface area and enables high wattage per unit area of heater with relatively low wattage per unit area of brick.

Note that while this configuration is described in terms of “horizontal” and “vertical”, these are not absolute degree or angle restrictions. Advantageous factors include maintaining a thermocline and providing for fluid flow through the stack in a direction that results in convective heat transfer, exiting the stack at a relatively hotter portion of the thermocline. An additional advantageous factor that may be incorporated is to position the stack in a manner that encourages buoyant, hot air to rise through the stack and exit at the hot end of the thermocline; in this case, a stack in which the hot end of the thermocline is at a higher elevation than the cold end of the thermocline is effective, and a vertical thermocline maximizes that effectiveness.

An important advantage of this design is that uniformity of heating element temperature is strongly improved in designs according to the present disclosure. Any variations in brick heat conductivity, or any cracks forming in a brick that result in changed heat conductivity, are strongly mitigated by radiation heat transfer away from the location with reduced conductivity. That is, a region reaching a higher temperature than nearby regions due to reduced effectiveness of internal conduction will be out of radiation balance with nearby surfaces, and will as a result be rapidly cooled by radiation to a temperature relatively close to that of surrounding surfaces. As a result, both thermal stresses within solid media, and localized peak heater temperatures, are reduced by a large factor compared to previous teachings.

The system may include one or more air blowing units including any combination of fans and, blowers, and configured at predefined positions in the housing to facilitate the controlled flow of air between a combination of the first section, the second section, and the outside environment. The first section may be isolated from the second section by a thermal barrier. The air blowing units may facilitate the flow of air through at least one of the channels of the bricks from the bottom end of the cells to the upper end of the cells in the first section at the predefined flow rate, and then into the second section, such that the air passing through the bricks and/or heating elements of the cells at the predefined flow rate may be heated to a second predefined temperature, and may absorb and transfer the thermal energy emitted by the heating elements and/or stored by the bricks within the second section. The air may flow from the second section across a steam generator or other heat exchanger containing one or more conduits, which carry a fluid, and which, upon receiving the thermal energy from the air having the second predefined temperature, may heat the fluid flowing through the conduit to a higher temperature or may convert the fluid into steam. Further, the system may facilitate outflow of the generated steam from the second end of the conduit, to a predefined location for one or more industrial applications. The second predefined temperature of the air may be based on the material being used in conduit, and the required temperature and pressure of the steam. In another implementation, the air leaving the second section may be delivered externally to an industrial process.

Additionally, the example implementations described herein disclose a resistive heating element. The resistive heating element may include a resistive wire. The resistive wire may have a cross-section that is substantially round, elongated, flat, or otherwise shaped to admit as heat the energy received from the input of electrical energy.

Passive Cooling

FIG. 6 provides an isometric view of the thermal storage unit with multiple vent closures open, according to some implementations. Therefore, FIG. 6 may represent a maintenance or failsafe mode of operation. As shown, the thermal storage unit also includes an inner enclosure 623. The outer surface of inner enclosure 623 and the inner surface of the outer enclosure define a fluid passageway through which fluid may be conducted actively for dynamic cooling or passively for failsafe operation.

Inner enclosure 623 includes two vents 615 and 617 which include corresponding vent closures in some implementations (portions of vent door 613, in this example). In some implementations, vents 615 and 617 define respective passages between an interior of the inner enclosure 623 and an exterior of the inner enclosure. When the external vent closure 603 is open, these two vents are exposed to the exterior of the outer enclosure as well.

As shown, vent 615 may vent heated fluid from the thermal storage blocks conducted by duct 619. The vent 617 may allow entry of exterior fluid into the fluid passageway and eventually into the bottoms of the thermal storage block assemblies via louvers 611 (the vent closure 609 may remain closed in this situation). In some implementations, the buoyancy of fluid heated by the blocks causes it to exit vent 615 and a chimney effect pulls external fluid into the outer enclosure via vent 617. This external fluid may then be directed through louvers 611 due to the chimney effect and facilitate cooling of the unit. Speaking generally, a first vent closure may open to output heated fluid and a second vent closure may open to input external fluid for passive venting operation.

During passive cooling, the louvers 611 may also receive external fluid directly, e.g., when vent closure 609 is open. In this situation, both vents 615 and 617 may output fluid from the inner and outer enclosures.

Vent door 613 in the illustrated implementation, also closes an input to the steam generator when the vents 615 and 617 are open. This may prevent damage to steam generator components (such as water tubes) when water is cut off, the blower is not operating, or other failure conditions. The vent 617 may communicate with one or more blowers which may allow fluid to passively move through the blowers even when they are not operating. Speaking generally, one or more failsafe vent closure may close one or more passageways to cut off fluid heated by the thermal storage blocks and reduce or avoid equipment damage.

When the vent door 613 is closed, it may define part of the fluid passageway used for dynamic insulation. For example, the fluid movement system may move fluid up along one wall of the inner enclosure, across an outer surface of the vent door 613, across a roof of the inner enclosure, down one or more other sides of the inner enclosure, and into the thermal storage blocks (e.g., via louvers 611). Louvers 611 may allow control of fluid flow into assemblages of thermal storage blocks, including independent control of separately insulated assemblages in some implementations.

In the closed position, vent door 613 may also define an input pathway for heated fluid to pass from the thermal storage blocks to duct 619 and beneath the vent door 613 into the steam generator to generate steam.

In some implementations, one or more of vent door 613, vent closure 603, and vent closure 609 are configured to open in response to a nonoperating condition of one or more system elements (e.g., nonoperation of the fluid movement system, power failure, water failure, etc.). In some implementations, one or more vent closures or doors are held in a closed position using electric power during normal operation and open automatically when electric power is lost or in response to a signal indicating to open.

In some implementations, one or more vent closures are opened while a fluid blower is operating, e.g., to rapidly cool the unit for maintenance.

Thermoelectric Power Generation

1. Problems to be Solved

Gasification is the thermal conversion of organic matter by partial oxidation into gaseous product, consisting primarily of H₂, carbon monoxide (CO), and may also include methane, water, CO₂ and other products. Biomass (e.g., wood pellets), carbon rich waste (e.g. paper, cardboard) and even plastic waste can be gasified to produce hydrogen rich syngas at high yields with high temperature steam, with optimum yields attained at >1000° C. The rate of formation of combustible gases are increased by increasing the temperature of the reaction, leading to a more complete conversion of the fuel. The yield of hydrogen, for example, increases with the rise of reaction temperature.

Turning waste carbon sources into a useable alternative energy or feedstock stream to fossil fuels is a potentially highly impactful method for reducing carbon emissions and valorizing otherwise unused carbon sources.

2. Thermoelectric Power Generation

Indirect gasification uses a Dual Fluidized Bed (DFB) system consisting of two intercoupled fluidized bed reactors—one combustor and one gasifier—between which a considerable amount of bed material is circulated. This circulating bed material acts as a heat carrier from the combustor to the gasifier, thus satisfying the net energy demand in the gasifier originated by the fact that it is fluidized solely with steam, i.e., with no air/oxygen present, in contrast to the classical approach in gasification technology also called direct gasification. The absence of nitrogen and combustion in the gasifying chamber implies the generation of a raw gas with much higher heating value than that in direct gasification. The char which is not converted in the gasifying chamber follows the circulating bed material into the combustor, which is fluidized with air, where it is combusted and releases heat which is captured by the circulating bed material and thereby transported into the gasifier in order to close the heat balance of the system.

Referring to FIG. 4, in some example implementations, the thermal energy storage structure 403 can be integrated directly with a steam power plant to provide an integrated cogeneration system 400 for a continuous supply of hot air, steam and/or electrical power for various industrial applications. Thermal storage structure 403 may be operatively coupled to electrical energy sources 401 to receive electrical energy and convert and store the electrical energy in the form of thermal energy. In some implementations, at least one of the electrical energy sources 401 may comprise an input energy source having intermittent availability. However, electrical energy sources 401 may also include input energy sources having on-demand availability, and combinations of intermittent and on-demand sources are also possible and contemplated. The system 403 can be operatively coupled to a heat recovery steam generator (HRSG) 409 which is configured to receive heated air from the system 403 for converting the water flowing through conduits 407 of the HRSG 409 into steam for the steam turbine 415. In an alternative implementation, HRSG 409 is a once-through steam generator in which the water used to generate steam is not recirculated. However, implementations in which the water used to generate steam is partially or fully circulated as shown in FIG. 4 are also possible and contemplated.

A control unit can control the flow of the heated air (and more generally, a fluid) into the HRSG 409, based on load demand, cost per KWH of available energy source, and thermal energy stored in the system. The steam turbine 415 can be operatively coupled to a steam generator 409, which can be configured to generate a continuous supply of electrical energy. Further, the steam turbine 415 can also release a continuous flow of relatively lower-pressure 421 steam as output to supply an industrial process. Accordingly, implementations are possible and contemplated in which steam is received by the turbine at a first pressure and is output therefrom at a second, lower pressure, with lower pressure steam being provided to the industrial process. Examples of such industrial process that may utilize the lower pressure output steam include (but are not limited to) production of liquid transportation fuels, including petroleum fuels, biofuel production, production of diesel fuels, production of ethanol, grain drying, and so on.

The production of ethanol as a fuel from starch and cellulose involves aqueous processes including hydrolysis, fermentation and distillation. Ethanol plants have substantial electrical energy demand for process pumps and other equipment, and significant demands for heat to drive hydrolysis, cooking, distillation, dehydrating, and drying the biomass and alcohol streams. It is well known to use conventional electric power and fuel-fired boilers, or fuel-fired cogeneration of steam and power, to operate the fuel production process. Such energy inputs are a significant source of CO₂ emissions, in some cases 25% or more of total CO₂ associated with total agriculture, fuel production, and transportation of finished fuel. Accordingly, the use of renewable energy to drive such production processes is of value. Some ethanol plants are located in locations where excellent solar resources are available. Others are located in locations where excellent wind and solar resources are available.

The use of electrothermal energy storage may provide local benefits in such locations to grid operators, including switchable electricity loads to stabilize the grid; and intermittently available grid electricity (e.g., during low-price periods) may provide a low-cost continuous source of energy delivered from the electrothermal storage unit.

The use of renewable energy (wind or solar power) as the source of energy charging the electrothermal storage may deliver important reductions in the total. CO₂ emissions involved in producing the fuel, as up to 100% of the driving electricity and driving steam required for plant operations may come from cogeneration of heat and power by a steam turbine powered by steam generated by an electrothermal storage unit. Such emissions reductions are both valuable to the climate and commercially valuable under programs which create financial value for renewable and low-carbon fuels.

The electrothermal energy storage unit having air as a heat transfer fluid may provide other important benefits to an ethanol production facility, notably in the supply of heated dry air to process elements including spent grain drying. One useful combination of heated air output and steam output from a single unit is achieved by directing the outlet stream from the HRSG to the grain dryer. In this manner, a given amount of energy storage material (e.g., brick) may be cycled through a wider change in temperature, enabling the storage of extra energy in a given mass of storage material. There may be periods where the energy storage material temperature is below the temperature required for making steam, but the discharge of heated air for drying or other operations continues.

In some implementations thermal storage structure 403 may be directly integrated to industrial processing systems in order to directly deliver heat to a process without generation of steam or electricity. For example, thermal storage structure 403 may be integrated into industrial systems for manufacturing lime, concrete, petrochemical processing, or any other process that requires the delivery of high temperature air or heat to drive a chemical process. Through integration of thermal storage structure 403 charged by VRE, the fossil fuel requirements of such industrial process may be significantly reduced or possibly eliminated.

The control unit can determine how much steam is to flow through a condenser 419 versus steam output 421, varying both total electrical generation and steam production as needed. As a result, the integrated cogeneration system 400 can cogenerate steam and electrical power for one or more industrial applications.

If implemented with an OT SG as shown in FIG. 3 instead of the recirculating HRSG shown in FIG. 5, the overall integrated cogeneration system 400 can be used as thermal storage once-through steam generator (TSOTG) which can be used in oil fields and industries to deliver wet saturated steam or superheated dry steam at a specific flow rate and steam quality under automated control. High temperature delivered by the bricks and heating elements of the system 403 can power the integrated heat recovery steam generator (HRSG) 409. A closed air recirculation loop can minimize heat losses and maintain overall steam generation efficiency above 98%.

The HRSG 409 can include a positive displacement (PD) pump 411 under variable frequency drive (VFD) control to deliver water to the HRSG 409. Automatic control of steam flow rate and steam quality (including feed-forward and feed-back quality control) can be provided by the TSOTG 400. In an exemplary example implementation, a built-in Local Operator Interface (LOI) panel operatively coupled to system 400 and the control unit can provide unit supervision and control. Further, thermal storage structure 403 can be connected to a supervisory control and data acquisition system (SCADA)) associated with the steam power plant (or other load system). In one implementation, a second electrical power source is electrically connected to the steam generator pumps, blowers, instruments, and control unit.

In some implementations, system 400 may be designed to operate using feedwater with substantially dissolved solids; accordingly, a recirculating boiler configuration is impractical. Instead, a once-through steam generation process can be used to deliver wet steam without the buildup of mineral contaminants within the boiler. A serpentine arrangement of conduits 407 in an alternative once-through configuration of the HRSG 409 can be exposed to high-temperature air generated by the thermal storage structure 403, in which preheating and evaporation of the feedwater can take place consecutively. Water can be forced through the conduits of HRSG 409 by a boiler feedwater pump, entering the HRSG 409 at the “cold” end. The water can change phase along the circuit and may exit as wet steam at the “hot” end. In one implementation, steam quality is calculated based on the temperature of air provided by the thermal storage structure 403, and feedwater temperatures and flow rates, and is measured based on velocity acceleration at the HRSG outlet. Embodiments implementing a separator to separate steam from water vapor and determine the steam quality based on their relative proportions are also possible and contemplated.

In the case of an OTSG implementation, airflow (or other fluid flow) can be arranged such that the hottest air is nearest to the steam outlet at the second end of the conduit. An OTSG conduit can be mounted transversely to the airflow path and arranged in a sequence to provide highly efficient heat transfer and steam generation while achieving a low cost of materials. As a result, other than thermal losses from energy storage, steam generation efficiency can reach above 98%. The prevention of scale formation within the tubing is an important design consideration in the selection of steam quality and tubing design. As water flows through the serpentine conduit, the water first rises in temperature according to the saturation temperature corresponding to the pressure, then begins evaporating (boiling) as flow continues through heated conduits.

As boiling occurs, volume expansion causes acceleration of the rate of flow, and the concentration of dissolved solids increases proportionally with the fraction of liquid phase remaining. Maintaining concentrations below precipitation concentration limits is an important consideration to prevent scale formation. Within a bulk flow whose average mineral precipitation, localized nucleate and film boiling can cause increased local mineral concentrations at the conduit walls. To mitigate the potential for scale formation arising from such localized increases in mineral concentration, conduits which carry water being heated may be rearranged such that the highest temperature heating air flows across conduits which carry water at a lower steam quality, and that heating air at a lower-temperature flows across the conduits that carry the highest steam quality flow.

Returning to FIG. 6, various implementations are contemplated in which a fluid movement device moves fluid across a thermal storage medium, to heat the fluid, and subsequently to an HRSG such as HRSG 409 for use in the generation of steam. In one implementation, the fluid is air. Accordingly, air circulation through the HRSG 409 can be forced by a variable-speed blower, which serves as the fluid movement device in such an embodiment. Air temperature can be adjusted by recirculation/mixing, to provide inlet air temperature that does not vary with the state of charge of the bricks or other mechanisms used to implement a thermal storage unit. The HRSG 409 can be fluidically coupled to a steam turbine generator 415, which upon receiving the steam from the HRSG 409, causes the production of electrical energy using generator 417. Further, the steam gas turbine 415 in various embodiments releases low-pressure steam that is condensed to a liquid by a condenser 419, and then de-aerated using a deaerator 413, and again delivered to the HRSG 409.

### III. Voltage-Controlled Regulation Based Upon Input Variable Energy Sources

This Section III relates to systems and methods for voltage-controlled power grid regulation based upon input variable-energy source. In the following description, the electrical loads, the thermal energy storage system, thermal storage media, processes for use and variations thereon may be any of the range of implementations described throughout this application, including in any combination with the variations discussed above that were described in the aforementioned U.S. Pat. No. 11,603,776. Other loads can also be used, and the present disclosure is not limited thereto.

Example implementations described herein utilize inverters as a large-scale voltage-controlled source to control the power delivered to resistive loads by varying the voltage. Examples of loads that can be used can include, but are not limited to, one or more heating elements to heat a thermal energy storage medium, one or more electrode boilers, one or more electric furnaces, and so on in accordance with the desired implementation. The loads presented to the voltage-controlled sources can be controlled by a load controller as described herein.

Conventional systems utilize equipment which stabilizes voltage and extra equipment to match the load so that the output power does not exceed the power of the microgrid. Such solutions include some means of limiting the power consumption and/or regulating the load impedance to match (or at least to avoid exceeding) the generated power. Such solutions typically utilize an extra device to control the power and facilitate such power regulation, or require connection to a larger electricity grid which includes such devices. In addition, conventional systems typically include either a dedicated unlimited power source or a power source that is higher than the load rating.

In the example implementations described herein, the inverters operate as a variable voltage source that varies the voltage of the microgrid so that power generated by the inverters matches the load as P_{renewable}=V²/R, wherein:
P_{renewable} is the power available from the variable renewable energy source (e.g., solar panel, wind, etc.);
V is the microgrid voltage generated by the inverters; and
R is the load impedance.

Through the example embodiments described herein, the necessity of an extra device to control the power can be eliminated. By using a power-controlled approach (e.g., MPPT or preset power point management), the output voltage to the power grid (e.g., microgrid) can be regulated to match the available power provided by the variable renewable energy sources. As shown above, power, voltage, and impedance have a fixed relationship. In the present disclosure, the microgrid operating voltage is allowed to vary over a range. Allowing this voltage variation enables power delivery into the load at widely varying rates as available generation changes; the inverter MPPT controllers synthesize this varying voltage as available generation changes. A load controller may sense the microgrid operating voltage and cause changes in impedance which facilitate a wider range of power transfer; for example, when microgrid voltage rises to near the upper end of the operating range, impedance may be lowered by means such as connecting one or more additional heating elements to the microgrid; and when voltage drops to near the lower end of the operating range, impedance may be raised by selectively disconnecting or restricting one or more loads such as heater modules or heating elements. These embodiments can permit the load rating to be higher than the power source through voltage control and load circuit control (e.g., connecting and disconnecting loads) to maintain equilibrium. Such embodiments are particularly helpful for variable energy sources such as variable renewable energy sources. Such embodiments are also an improvement over conventional droop control systems, which rely on a constant power source (e.g., a battery) to drive power to match the load for when voltage falls below a nominal threshold. Such embodiments also eliminate the need to have a constant power source for use as a reference voltage, since the need for maintaining a constant power source to exceed the load rating is eliminated.

Conventional systems utilize MPPT to generate power based on operating in a current control mode as opposed to the innovative voltage-controlled design of the system described herein. However, current-controlled systems require an essentially constant voltage in the power grid to match the load, so as not to exceed the power of the microgrid. Accordingly, in such systems, an external device such as a controller with its associated power source or absorber, such as a battery or generator, is used to control or generate power in response to fluctuations in voltage from the underlying energy sources. In contrast, the example implementations described herein can utilize MPPT to modulate the output voltage of the microgrid without requiring another device such as a battery or generator.

In example implementations of the present disclosure, each individual inverter circuit can sense the available power (e.g., via MPPT) from their underlying variable energy sources and adjusts the output AC voltage waveform. One or more load controllers sense the microgrid AC voltage and adjust the total microgrid impedance by sending control signals which adjust the impedance currently presented by one or more loads.

In example implementations of the present disclosure, inverter circuits can function as independent maximum power point tracking/extracting devices that can either create AC signal or connect to existing AC signal in voltage control mode so that the chosen voltage waveform on the output enables deliver of the power available on the input as related voltage over the connected to the AC output load impedance. A single inverter circuit can create an AC power signal and find the equilibrium voltage point for the AC waveform at which available maximum power on the DC input can be delivered into the microgrid impedance. When multiple inverter circuits are connected together, any of the inverter circuits can be configured to be grid forming and create a voltage signal, while the rest of the inverter circuits can be in following voltage mode. The inverter circuits work continuously and independently. Each inverter MPPT algorithm influences the voltage of the AC waveform it attempts to deliver to its output, and either increases or decreases the magnitude of the output sine signal depending on the extracted DC power from the input. When a plurality of inverters operates concurrently, as each increases its power delivery, the aggregate AC waveform synthesized by the group of inverters will rise.

In example implementations, multiple inverter circuits can be connected to variable energy sources having various power levels, form a grid, and contribute the sum of all available power from the DC inputs. The inverter circuits can independently find and settle at the voltage equilibrium point that corresponds to the sum of all available DC power relative to the load impedance. In this case, each of the inverter circuits can deliver its maximum power.

In example implementations, a load controller senses the microgrid voltage and may adjust the impedance of one or more loads which may include resistive loads such as one or more heating elements in an Electro-thermal Energy Storage (ETES) system, one or more heating modules, one or more resistance or electrode boilers, and so on in accordance with the desired implementation. When the system voltage falls below a threshold value, the load controller acts to increase total microgrid impedance by controlling one or more load elements to increase impedance and/or disconnect. When system voltage rises above another threshold value, the load controller acts to decrease total microgrid impedance by controlling one or more loads to decrease impedance, or by connecting additional loads. Examples of load control can include, but is not limited to, an electrode boiler that adjusts its electrode positions or water level or a resistive heater configured to be connected or disconnected by a semiconductor or mechanical switch. Other examples of load control can include a plurality of load control devices such as thyristors switching in cycle-by-cycle patterns which may selectively connect different heating elements during each AC cycle in patterns which enable smooth changes in the power delivery to individual heaters, while presenting relatively constant aggregate impedance to the microgrid.

This operation of the load controller and connected loads result in varying the microgrid voltage in a manner so as to maintain voltage within an operating region in which the connected variable power source—inverter circuits embodying the present innovation—can deliver their full available energy without requiring external devices to otherwise stabilize the microgrid voltage or to adapt to the available power or in response to a power command from the load controller, which does not require an external device with an independent power source to control the power in the microgrid. Such example implementations allow for a very high amount of power to be controlled with the existing active electronics through software or microcontroller layer modifications, with some system coordination as described below.

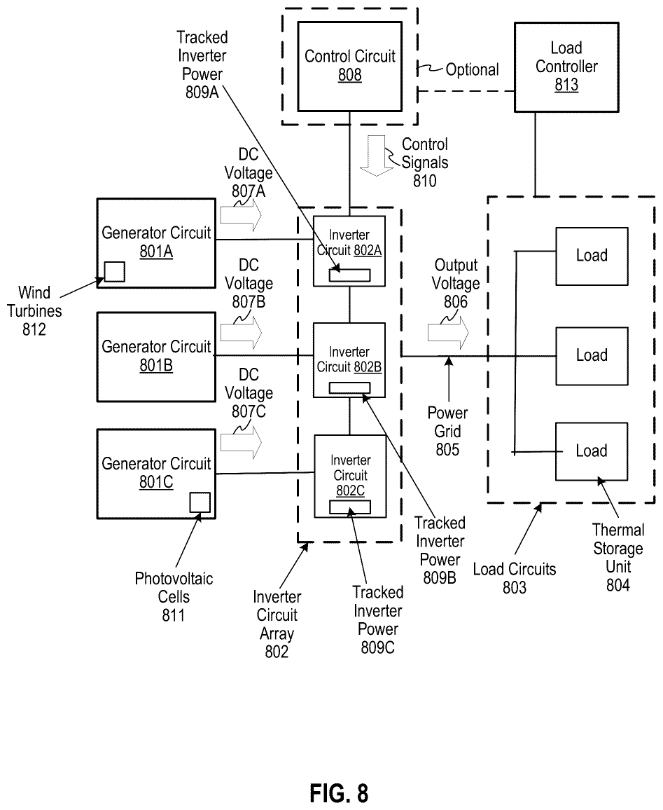

A block diagram of an embodiment of a power system is depicted in FIG. 7. As illustrated, power system includes generator circuits 701A-701C, inverter circuit array 702 which can involve one or more inverter circuits 702A-702C as shown therein, load circuits 703 associated with one or more loads, and optional control circuit 708. In the following description, the apparatus and processes disclosed and variations thereon may be used in connection with thermal energy storage systems in any of the implementations described throughout this application, including in any combination with the variations discussed above that were described in the aforementioned U.S. Pat. No. 11,603,776. The loads of the load circuits 703 can include the thermal energy storage systems described herein (illustrated here as thermal storage unit 704) and can be configured to connect to or disconnect from the grid, as well as to modify the impedance or adjust the power intake to the load in accordance with the desired implementation. The load circuits 703 can be controlled by a load controller 713. It should be understood that, in some embodiments, the inverter circuit array 702 may have inverter circuits 702A-702C housed in one or more separate inverters located in the same location or in separate locations.

Generator circuits 701A-701C are configured to generate respective DC voltages 707A-707C. In various embodiments, one or more of the generator circuits 701A-701C may include photovoltaic cells and/or wind turbines (e.g., photovoltaic cells 711, or wind turbines 712). Although three generator circuits are depicted in the embodiment of FIG. 7, in other embodiments, any suitable number of generator circuits may be employed. Similarly, although three inverter circuits are depicted in the embodiment of FIG. 7, in other embodiments, any suitable number of inverter circuits may be employed.

As described below, inverter circuit array 702 includes one or more inverter circuits 702A-702C configured to generate output voltage 706 on power grid 705 based upon the input voltage levels of DC voltages 707A-707C. In some embodiments, the power grid 705 may be a microgrid. It is noted that output voltage 706 may be an AC voltage. The inverter circuits 702A-702C are configured to adjust a value of output voltage 706 based on tracked generator power 709A-709C. Tracked generator power 709A-709C may include information indicative of respective power levels available from generator circuits 701A-701C, or indicative of the total power from all or some subset of the generator circuits. Individual inverter circuits may adjust their respective output voltages based upon respective amounts of power supplied by individual generator circuits 701A-701C or, as mentioned, based upon the amounts of power from some or all of those generator circuits.

In some embodiments, optional control circuit 708 can function as a generator controller and may be used to control the inverter circuits 702A-702C using control signals 710. In such cases, control circuit 708 may be configured to determine the amount of power from the tracked (i.e., measured) generator power 709A-709C. Control circuit 708 may be configured to generate individual ones of control signals 710 to adjust respective output voltages of the inverter circuits, which may be used to, for example, maximize power output or to regulate power output to a nominal voltage. Components 709A-709C can be implemented as a firmware and/or software module configured to receive a signal from power monitoring circuits 702A-7082C and to generate a control signal representing the power from the generators 701A-701C.

By adjusting the outputs of individual inverter circuits, the value of output voltage 706 is adjusted to compensate for variations in the power delivered, respectively, by generator circuits 701A-701C. For example, if one of the generator circuits 701A-701C reduces its power output, the corresponding inverter circuit (702A, 702B or 702C) reduces its power output accordingly, which can result in a drop in the output voltage 706. In this manner, the power available on power grid 705 can be used to track the power being provided by generator circuits 701A-701C.

Load circuits 703 can include any suitable number of load circuits that perform a function or work using power from output voltage 706. For example, in some embodiments, load circuits 703 include a thermal storage unit 704 which is configured to generate and store heat using power from output voltage 706. Depending on the desired implementation, load circuits 703 can be controlled by a load controller 713 to disconnect or connect their respective loads, to vary impedance to the loads so as to redistribute power to the loads, and so on. Load controller 713 may also be configured to be connected to the generation controller (e.g., control circuit 708) to provide information regarding the loads in accordance with the desired implementation. Such information can include, but is not limited to, the number of loads engaged, the impedances of the loads, and so on in accordance with the desired implementation. For example, if control circuit 708 receives the number of engaged loads from the load controller 713 indicating that all the loads are being engaged, control circuit 708 may thereby instruct any or all of the inverter circuits 702A-702C to maintain present power levels rather than maximize power.

In some cases, the output power of an inverter circuit array 702 can be used in lieu of, or in addition to, the power provided by generator circuits 701A-701C to regulate the voltage of a power grid.

In some embodiments, each of the inverter circuits in inverter circuit array 702 may be running its own control algorithm. These separate inverter circuits 702A-702C running their separate control algorithms will select the appropriate voltage for their output AC voltage. Because the separate control algorithms are each making their adjustments on an individual basis, this reduces “beating” or feedback instability. For example, when one inverter circuit increases power output, the whole system voltage rises a bit, and now the other inverter circuits are below their maximum power point. The other inverter circuits will find that and adjust their voltages. The system is stable as a whole.

Optionally, the load controller 713 operates in coordination with the inverter circuits 702A-702C to adjust the load when appropriate. If one or more of the generator circuits 701A-701C goes offline due to damage, lack of sunlight, lack of wind, or other reason, the load controller 713 can operate to increase overall system impedance by adjusting the load(s) connected to the system, including but not limited to disconnecting one or more loads. For example, for generator circuits based on solar arrays operating during peak sunlight with full power available, if one or more of the solar arrays goes offline due to construction damage or other catastrophic reason, one cannot leave the system impedance where it was, because the output voltage will fall. The other inverter circuits trying to run at full power will have to push much more current, but unfortunately, they cannot. To address this situation, the load controller 713 can detect or be alerted of such changes and adjust the load(s) connected to the system, raising the impedance and voltage. This allows the remaining sets of generator circuits and inverter circuits to deliver their full power. Of course, the load controller 713 can also operate to add additional load(s) to decrease impedance should the reverse scenario occur with the sudden addition of one or more generator circuits.

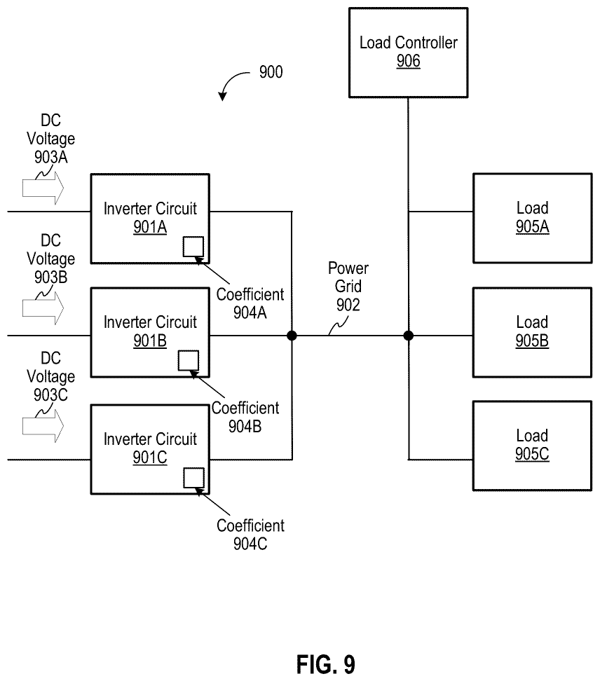

In FIG. 8, a block diagram of a different embodiment of a power system that employs the output power of an inverter circuit array is depicted. In this embodiment, power system includes generator circuits 801A-801C, inverter circuit array 802 which can include one or more inverter circuits 802A-802C, load circuits 803 associated with one or more loads, and optional control circuit 808. As in FIG. 7, the loads of the load circuits 803 can include thermal energy storage apparatus as described herein, such as thermal storage unit 804, in which case the load circuits 803 can be configured to connect or disconnect the thermal energy storage apparatus to the grid, as well as to modify impedances of the TES system in accordance with the desired implementation.

Generator circuits 801A-801C are configured to generate, respectively, power using DC voltages 807A-807C. In various embodiments, one or more of the generator circuits 801A-801C may include the same type of variable renewable energy sources as those of FIG. 7, such as photovoltaic cells and/or wind turbines (e.g., photovoltaic cells 811, or wind turbines 812). In the case of solar power, the respective voltage levels of DC voltages 807A-807C may be based on an illumination level of the photovoltaic cells. In general, the DC voltages 807A-807C may be time-varying in that differences in illumination levels of the photovoltaic cells, variations in wind speed, and the like can result in changes in the values of the DC voltages 807A-807C over time. Although three generator circuits are depicted in the embodiment of FIG. 8, in other embodiments any suitable number of generator circuits may be employed. Similarly, although three inverter circuits are depicted in the embodiment of FIG. 8, in other embodiments, any suitable number of inverter circuits may be employed. It should also be understood that, in some embodiments, the inverter circuit array may have inverter circuits housed in one or more separate inverters located in the same location as one another, or in separate locations.

As described below, inverter circuit array 802 includes one or more inverter circuits 802A-802C configured to generate power using output voltage 806 on power grid 805 based upon the input voltage levels of DC voltages 807A-807C. In some embodiments, the power grid 805 may be a microgrid. The inverter circuits 802A-802C are also configured to adjust a value of output voltage 806 based on tracked inverter power 809A-809C (in contrast to the tracked generator power 709A-709C in the embodiment of FIG. 7). As with 709A-709C, tracked inverter power 809A-809C may be implemented as a firmware and/or software module configured to receive a signal from power monitoring circuits, the signal including information indicative of respective output power levels available from the inverter circuits, and configured to generate a control signal representing the power from the generator circuits 801A-801C. Individual inverter circuits 802A-802C may adjust their respective output voltages based on their respective output powers—either the individual, respective output power levels, or the output power levels of all or some subset of the inverters. It is noted that the inverter circuits may additionally use information indicative of the respective power levels supplied by generator circuits 801A-801C to adjust their respective output voltages 806.

Optional control circuit 808 can function as a generator controller and may be used to control the inverter circuits 802A-802C using control signals 810. In such cases, control circuit 808 may be configured to determine the amount of power from the tracked inverter power 809A-809C. Control circuit 808 may be configured to generate individual ones of control signals 810 to adjust respective output voltages of the inverter circuits.

Load circuits 803 can include any suitable number of load circuits that perform a function or work using output voltage 806. For example, in some embodiments, load circuits 803 includes thermal storage unit 804, which is configured to generate and store heat using power with output voltage 806. Load circuits 803 can be controlled by a load controller 813 as described with respect to FIG. 7.

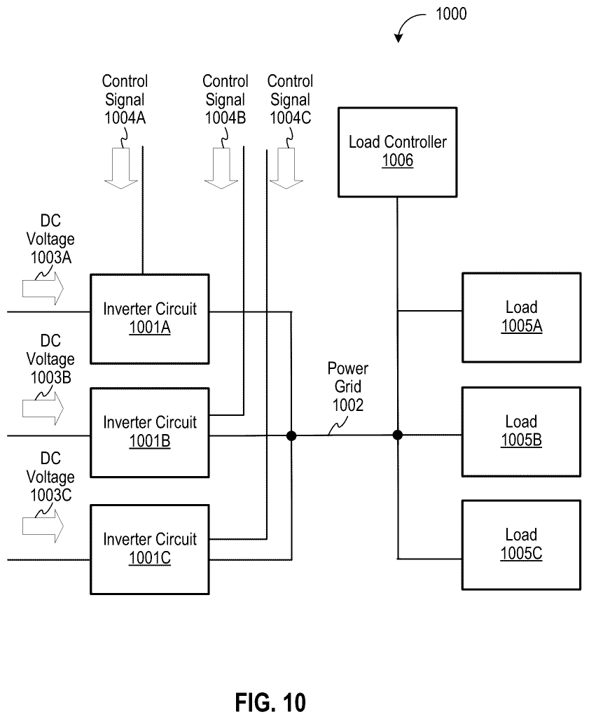

In FIG. 9, a block diagram of one embodiment of an inverter circuit array is depicted. As illustrated, inverter circuit array 900 includes inverter circuits 901A-901C. In various embodiments, inverter circuit array 900 may correspond to either inverter circuit array 702 or inverter circuit array 802 when optional control circuits 708 and 808 are not being used.

As seen in FIG. 9, inverter circuits 901A-901C are coupled to power grid 902. In various embodiments, power grid 902 may correspond to either power grid 705 or power grid 805 as depicted in the embodiments of FIG. 7 and FIG. 8, respectively. In some embodiments, the power grid 902 may be a microgrid, such as a power grid of a self-sufficient energy system that serves a particular geographic area. For example, a microgrid may be used to supply power to a medical complex, a business complex, a neighborhood, and the like.

Inverter circuits 901A-901C are configured to generate a particular voltage level on power grid 902 using corresponding ones of DC voltages 903A-903C. In various embodiments, individual contributions by inverter circuits 901A-901C to the voltage level of power grid 902 may be controlled by coefficients 904A-904C, respectively. Coefficients 904A-904C can correspond to scale factors for output power supplied by inverter circuits 901A-901C, respectively. Based on coefficients 904A-904C, different ones of the inverter circuits 901A-901C may adjust their respective contributions to the power flow to power grid 902 by varying their respective output voltages, output currents, switching frequencies, or any other suitable operational parameters according to coefficients 904A-904C.

In some embodiments, inverter circuits 901A-901C can be configured to adjust the voltage level of power grid 902 based on power being supplied by energy sources (e.g., intermittent or variable green energy sources) that generate DC voltages 903A-903C. In some embodiments, the inverter circuits 901A-901C are configured to adjust the voltage level of power grid 902 based on respective maximum power levels of the energy sources or using preset power points for the energy sources.

In other embodiments, inverter circuits 901A-901C can be configured to adjust the voltage level of power grid 902 based on the respective output power levels of the inverter circuits; as described above, this can be on the basis of individual inverter circuit power levels, or the power levels or all or some subset of the inverters. As in the case when the input power is supplied by the variable energy sources, inverter circuits 901A-901C can be configured to adjust the voltage level of power grid 902 based on the respective maximum power levels of inverter circuits 901A-901C or using preset points associated with the inverter circuits 901A-901C.

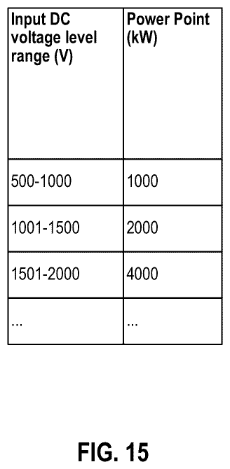

In some embodiments, each of the inverter circuits 901A-901C includes a transformer, a semiconductor-based relay or switch, and a microcontroller. Each microcontroller may be configured to track maximum power received from a corresponding one of the energy sources supplying DC voltages 903A-903C, and to adjust a corresponding one of the coefficients 904A-904C based on the corresponding maximum power level. An example block diagram of the inverter circuits 901A-901C is described with respect to FIG. 14.

It is noted that although only three inverter circuits are depicted in the embodiment of FIG. 9, in other embodiments, any suitable number of inverter circuits may be employed. In some embodiments, a number of inverter circuits included in an inverter circuit array may be based on a number of energy sources being employed, an available amount of power being delivered to the inverter circuits, respective power ratings of the inverter circuits, or any other suitable metric.

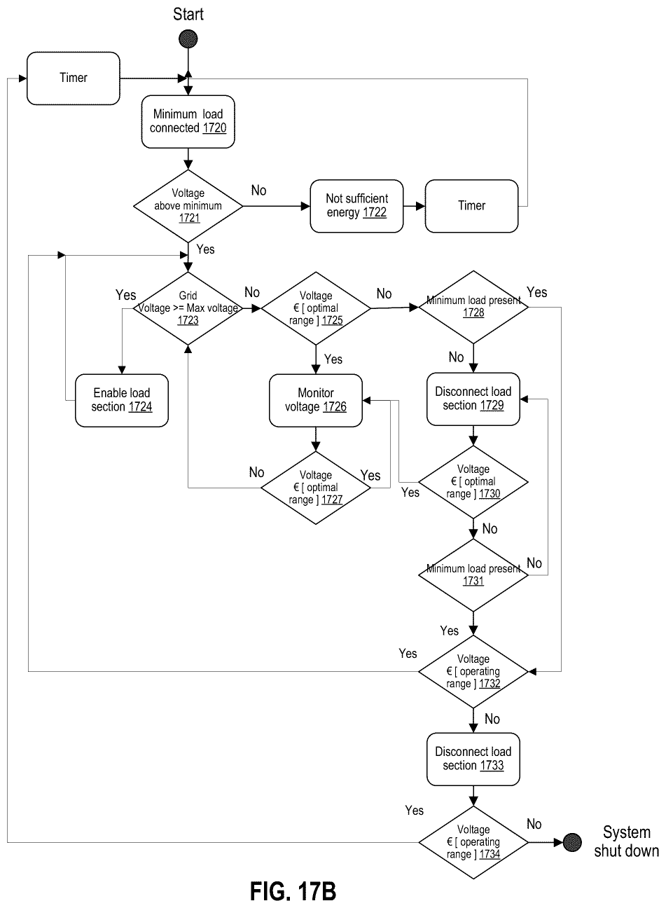

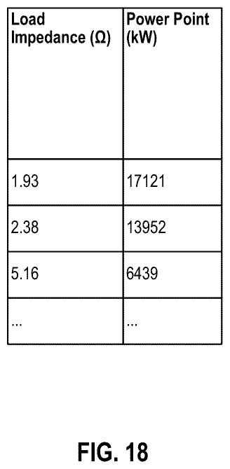

Once power is provided to the power grid 902 via inverter circuits 901A-901C, the power can be distributed to loads 905A-905C as controlled by the load circuits as described herein. Loads 905A-905C can be configured to be connected or disconnected to the power grid 902 by a switch or some other circuit in accordance with the desired implementation and in accordance with the nature of the underlying load. In other example implementations, the connection and disconnection to the grid can be managed by load controller 906, which can connect or disconnect loads based on the detected voltage to the power grid 902 as described with respect to FIG. 17A and FIG. 17B.

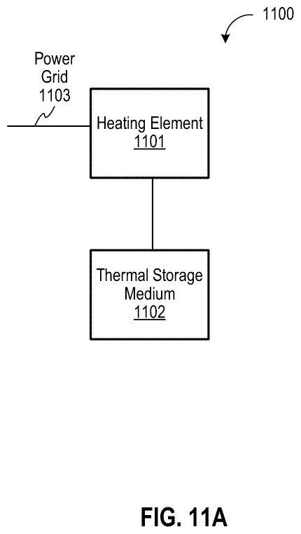

As described above, an optional control circuit may be used in conjunction with an inverter array circuit to function as a controller. A block diagram of an embodiment of an inverter circuit array that is configured to use an external control circuit is depicted in FIG. 10. As illustrated, inverter circuit array 1000 includes inverter circuits 1001A-1001C. In various embodiments, inverter circuit array 1000 may correspond to either inverter circuit array 702 or inverter circuit array 802 when optional control circuits 708 and 808, respectively, are being used.

Inverter circuits 1001A-1001C are coupled to power grid 1002. In various embodiments, power grid 1002 may correspond to either power grid 705 or power grid 805 as depicted in the embodiments of FIG. 7 and FIG. 8, respectively.

Inverter circuits 1001A-1001C are configured to generate a particular voltage level on power grid 1002 using corresponding ones of DC voltages 1003A-1003C. Individual contributions by inverter circuits 1001A-1001C to the voltage level of power grid 1002 may be controlled by control signals 1004A-1004C. Based on control signals 1004A-1004C, different ones of inverter circuits 1001A-1001C may adjust their respective contributions to the voltage level of power grid 1002 by varying their respective output voltages. In various embodiments, control signals 1004A-1004C may correspond to controls signals 710 or control signals 810 as depicted in FIG. 7 and FIG. 8, respectively.

In some embodiments, control signals 1004A-1004C are used to adjust respective output voltages of inverter circuits 1001A-1004C based on power supplied by corresponding energy sources (e.g., tracked generator power 709 of generator circuits 701A-701C as described above relative to FIG. 7). In other embodiments, control signals 1004A-1004C are used to adjust the respective output voltages of inverter circuits 1001A-1001C based on respective output power levels of inverter circuits 1001A-1001C (e.g., tracked inverter power 809A-809C as described above relative to FIG. 8).

In various embodiments, each of inverter circuits 1001A-1001C includes a transformer, a semiconductor-based relay or switch, and a microcontroller. In various embodiments, the microcontroller is configured to adjust a switching frequency of the relay or switch based on control signals 1004A-1004C. An example block diagram of the inverter circuits 901A-901C is described with respect to FIG. 14.

Once power is provided to the power grid 1002 via inverter circuits 1001A-1001C, the power can be distributed to loads 1005A-1005C as controlled by the load circuits as described herein. Loads 1005A-1005C can be configured to be connected or disconnected to the power grid 1002 by a switch or some other circuit in accordance with the desired implementation and in accordance with the nature of the underlying load. In other example implementations, the connection and disconnection to the grid can be managed by load controller 1006, which can connect or disconnect loads based on the detected voltage to the power grid 902 as described with respect to FIG. 17A and FIG. 17B.

It is noted that although only three inverter circuits are depicted in the embodiment of FIG. 10, in other embodiments, any suitable number of inverter circuits may be employed. In some embodiments, a number of inverter circuits included in an inverter circuit array may be based on a number of energy sources being employed, the available power level being delivered to the inverter circuits, respective power ratings of the inverter circuits, or any other suitable metric. It is noted that although inverter circuits 1001A-1001C are depicted as receiving a corresponding DC from a corresponding generator circuit, in other embodiments, more than one inverter circuit may receive a common DC voltage from a single generator circuit.

Some microgrids, depending on the specific amount of generation and load that is interconnected, and depending on currently available VRE, may have periods during which more power is available from the interconnected VRE sources than can be absorbed by the microgrid loads. Such situations result in curtailment of generation. In periods when more power is available than the total load can accept, the microgrid voltage rises to an upper operating limit, and power delivery cannot be further increased (unless a load controller can lower the microgrid impedance by selectively enabling or connecting more loads). If all inverter circuits are configured with the same upper voltage limit, such curtailment may be distributed roughly proportionally across the inverters. It may be technically and commercially beneficial, however, to prioritize different VRE sources so as to cause curtailment to be distributed unequally. Under the present disclosure, a system controller can establish a different maximum operating voltage for different inverters connected to the microgrid. During periods of excess generation, those inverters with a relatively lower maximum operating voltage will selectively reduce (curtail) their power output before those with a higher maximum operating voltage. For example, a first set of inverter circuits can be configured with a maximum operating voltage value V1, and a second set of inverter circuits can be configured with a maximum operating voltage value V2 that is greater than V1.

Depending on the desired implementation, it may be beneficial to allocate the curtailment automatically in a manner that prefers one portion of the underlying energy sources over another portion of the underlying energy sources. For example, suppose there are two solar fields involving two separate groups of inverter circuits being built at different times by different parties, and interconnected to the same microgrid. The later-built system can be configured to accept all curtailment (e.g., it must be completely curtailed before the first system begins to be curtailed) during periods of excess generation or inadequate load.

By commanding the inverters of the second-built system to operate at V1, and the first-built system to operate at V2, as system voltage reaches a point above V1, the second-built inverters will be operating their solar panels “off-maximum,” and being restricted in their power output, whereas the earlier-built system will continue to be free to seek the optimal point. Thus, by design, the earlier-built system should not experience losses in its annual output caused by the presence of the second-built system.

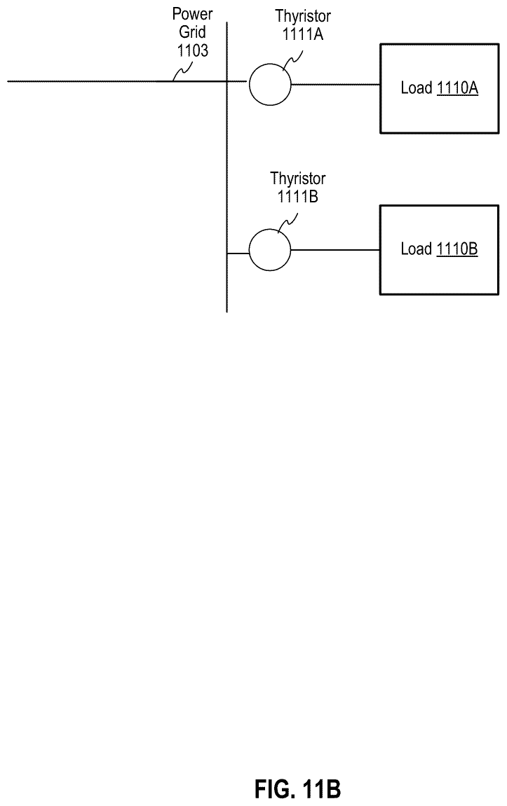

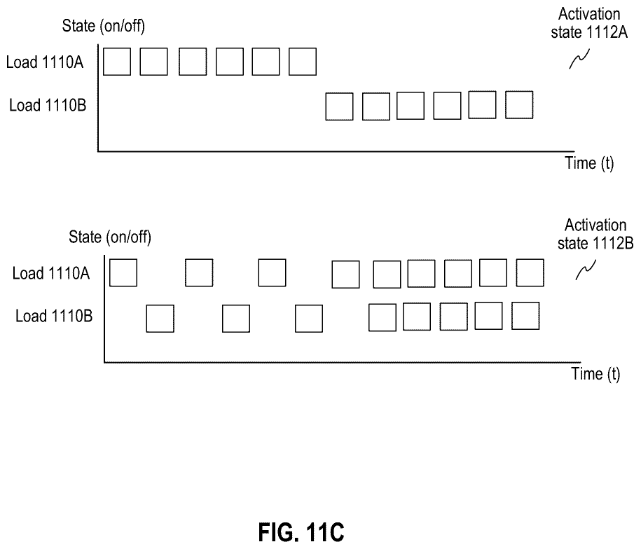

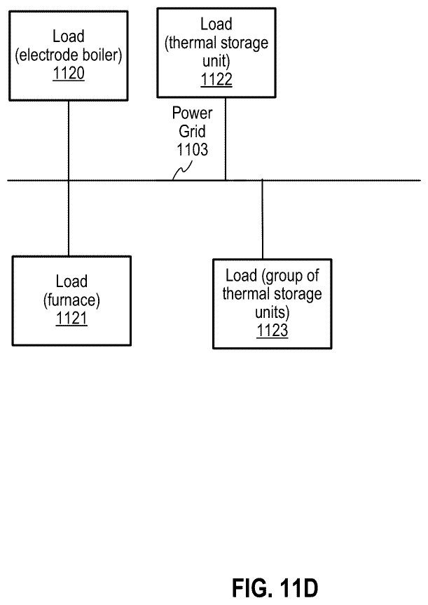

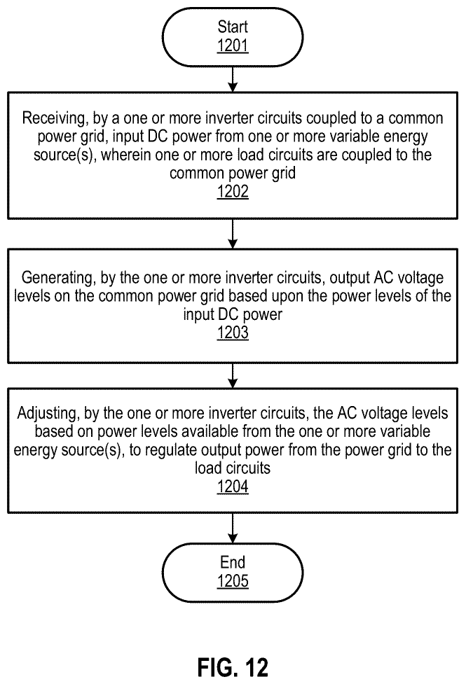

A block diagram of an embodiment of a thermal storage unit is depicted in FIG. 11A. As illustrated, thermal storage unit 1100 includes heating element 1101 and thermal storage medium 1102. In various embodiments, thermal storage unit 1100 may correspond to either of thermal storage unit 704 or thermal storage unit 804 as depicted in FIG. 7 and FIG. 8, respectively. As noted above, thermal storage unit 1100 may be implemented as thermal energy storage system 10 described above, including in any of the variations of apparatus, processes and applications as described herein.

Heating element 1101 is coupled to power grid 1103 and to thermal storage medium 1102. Power grid 1103 may, in some embodiments, correspond to either of power grid 705 or power grid 805 as depicted in FIG. 7 and FIG. 8, respectively. In various embodiments, heating element 1101 is positioned to heat thermal storage medium 1102 using power received via power grid 1103. Thermal storage unit 1100 may be implemented using a variety of different thermal storage media. For ease of illustration, load circuits corresponding to reference numerals 703 or 803 are not shown in FIG. 11A.

As described above, the voltage of power grid 1103 may be an alternating current (AC) voltage. In such cases, thermal storage unit 1100 may include an AC-to-DC converter circuit (not shown) configured to generate a DC voltage using the voltage level of power grid 1103, and heating element 1101 may be configured to heat thermal storage medium 1102 using the generated DC voltage.

Although only a single heating element is depicted in the embodiment of FIG. 11A, in other embodiments, any suitable number of heating elements may be employed. In some embodiments, multiple heating elements may be electrically connected in parallel and/or in series to the power grid and interspersed throughout thermal storage medium 1102.

FIG. 11B illustrates another example embodiment involving loads and thyristors for the load circuits. It is well known to control resistive electrical loads connected to AC power using thyristor devices of several types. Thyristors may be “fired”—turned on—at different times during an AC power cycle. Firing thyristors partway through a cycle reduces the total power transfer, but may induce waveform distortion and noise, and may cause unacceptable real and reactive energy flows which would require a battery or generator for stability. A plurality of thyristors (e.g., 1111A, 1111B), each controlling one or a plurality of resistive electrical loads (e.g., 1110A, 1110B), may be controlled so as to connect a chosen number of such loads for a full cycle—switching at the zero crossing (so-called Zero-Firing Thyristor or ZFT operation), so as to adjust the total impedance presented by the set of loads without introducing noise or waveform distortion.

As seen FIG. 11C, a group of thyristors may be commanded to operate a portion of total electrical loads in a relatively time-sequential means—for example, turning on some loads for a first period, then turning on other loads during a second period, where the periods may be minutes or hours in duration, as shown at the activation state diagram 1112A. In this case, each single load is relatively “on” or “off” for such period. As shown in activation state diagram 1112A, each load is activated at full power, one after another.

A controller may also command a ZFT operation pattern for a plurality of loads where ZFT firings are selected on a cycle-by-cycle basis, as shown in activation state diagram 1112B of FIG. 11C. In such a case, during any period such as minutes or hours duration, a relatively constant total load impedance may be presented by the group of thyristors and loads, but individual load power may be adjusted smoothly from very low power to full power by adjusting the firing frequency of each thyristor. In the example activation state diagram 1112B, both loads are turned on at 50% power, then proceeds to full power with both loads connected. However, the microgrid and the inverter circuits will see that the grid is operating at half power with the same impedance.

Although FIG. 11C shows only two heaters and two heating patterns, any suitable number of heaters may be employed and firing patterns may be adjusted to interleave additional heaters into the “on”/“off” pattern. For example, when working with three heaters, the pattern in activation state diagram 1112B can be extended to add another heater into the “on”/“off” pattern to ensure that the third heater is fired “on” before repeating the pattern with the firing “on” of the first heater. Optionally, one non-limiting example of bringing an individual heater from low power to full power may involve by firing a ZFT once every 10 AC cycles, then firing every 5 cycles, then firing every other cycle, or some other pattern as suitable. When implemented in multiple heaters, this firing sequence could be interleaved in an alternating, time-sequential or other pattern as suitable, such as shown in FIG. 11C, to present a smooth adjustment of the net impedance. Heaters typically prefer a gradual cool-down or gradual heat-up, and these smooth power-ups or power-downs can help extend heater life span in part by minimizing thermal shock to any coatings or materials on the heaters.

Although FIG. 11B is described with respect to thyristors, the present disclosure is not limited to the use of thyristors as switches; any suitable power-switching devices can be used in accordance with the desired implementations.

FIG. 11D illustrates an example of various load configurations that can be employed by the embodiments herein. Any of the loads described herein, in single or in combination, can be deployed for use in the embodiments described herein. Examples of loads can involve, but are not limited to, an electrode boiler 1120, a furnace or kiln 1121, a thermal storage unit 1122, multiple thermal storage units grouped together 1123, or any suitable combination of the foregoing. In an example implementation, multiple heaters can be configured to heat a single thermal storage medium, or there can be a group of thermal storage media operating together to form a particular load. Other resistive loads can also be used, alternatively or in combination with one or more thermal storage media, in accordance with the desired implementation.

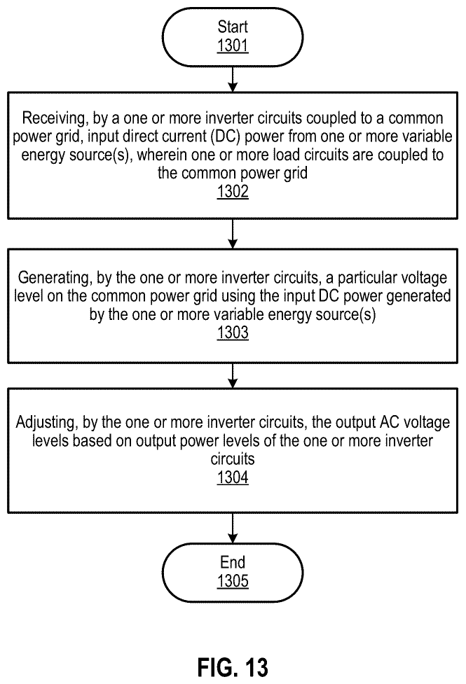

FIG. 12 is a flow diagram depicting an embodiment of a method providing power to a power grid such as a microgrid. The method of this flow diagram begins with block 1201, and may be applied to various power systems, including a power system as depicted in FIG. 7.

The method includes receiving, by one or more inverter circuits coupled to a power grid, input direct current (DC) power from one or more variable energy sources (block 1202). In some embodiments, load circuits can be coupled to the power grid. In various embodiments, the load circuits may include a heating element. In such cases, the method may also include heating, by the heating element, a thermal storage medium using the voltage level of the power grid. The input DC power (e.g., P_{renewable}) can be tracked and detected by an MPPT algorithm executed by the one or more inverter circuits or can also be based on the input DC voltage level received.

In some embodiments, a given variable energy source of the plurality of energy sources includes a plurality of photovoltaic cells or other variable energy source. In an example involving solar panels with such photovoltaic cells, the method may include generating, by the one or more variable energy sources, an input DC voltage level based on a level of illumination of the plurality of photovoltaic cells, the input DC voltage level representing the input DC power. It is noted that although the use of photovoltaic cells is described above, in other embodiments, other renewable energy sources, such as wind turbines, may be employed as well as combinations of different types of renewable energy sources.

The method further includes generating, by the one or more inverter circuits, output AC voltage levels on the power grid based upon power levels of the input DC power (block 1203).

The method also includes adjusting, by the one or more inverter circuits, the AC voltage levels on the power grid based on power levels available from the one or more variable energy sources, to regulate output power from the power grid to the load circuits (block 1204). In some embodiments, adjusting the voltage level of the power grid includes tracking respective maximum power levels supplied by each of the one or more variable energy sources, and adjusting the output AC voltage levels of the power grid based on the respective maximum power levels supplied by the one or more variable energy sources or based on a power defined by a control circuit (e.g., set by control circuits 708 or 808 as depicted in FIGS. 7 and 8, respectively). In other embodiments, adjusting the voltage levels on the power grid includes adjusting the voltage level on the power grid based on respective preset power points for the power levels supplied by the one or more variable energy sources. The method concludes in block 1205.

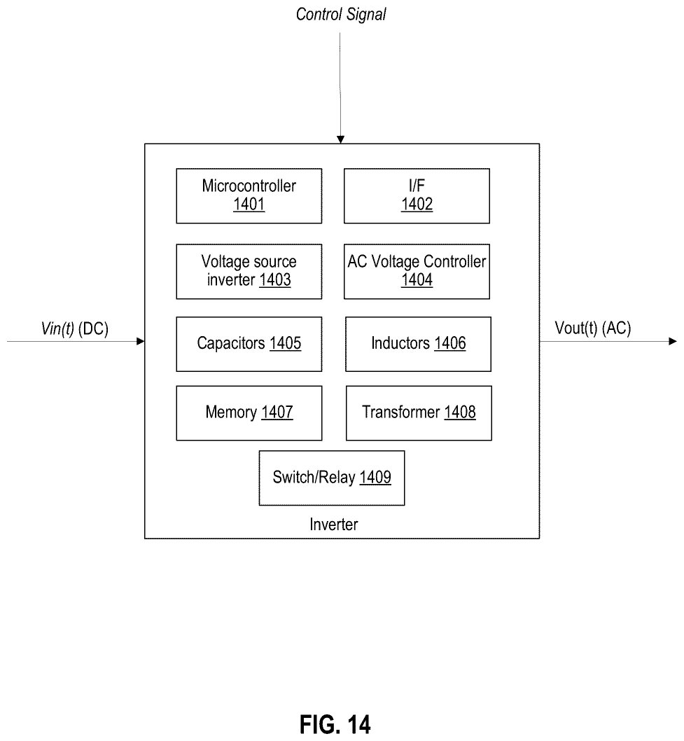

Turning to FIG. 13, a flow diagram depicting an embodiment of another method for providing power to a microgrid is illustrated. The method, which may be applied to various power systems including power system as depicted in FIG. 8, begins in block 1301.

The method includes receiving, by one or more inverter circuits coupled to a power grid, input direct current (DC) power from one or more variable energy sources (block 1302). In various embodiments, load circuits are coupled to the power grid. In some embodiments, the load circuits may include a heating element. In such cases, the method may also include heating, by the heating element, a thermal storage medium using the voltage level of the power grid. The input DC power (e.g., P_{renewable}) can be tracked and detected by an MPPT algorithm executed by the one or more inverter circuits or can also be based on the input DC voltage level received.

In some embodiments, the one or more variable energy sources can involve a plurality of photovoltaic cells. In an example involving a solar panel with such photovoltaic cells, the method may include generating, by the one or more variable energy sources, an input DC voltage level based on a level of illumination of the plurality of photovoltaic cells. It is noted that although the use of photovoltaic cells is described above, in other embodiments, other renewable energy sources, such as wind turbines, may be employed as well as combinations of different types of renewable energy sources.

The method further includes generating, by the one or more inverter circuits, a particular voltage level on the power grid using the input DC voltage level generated by the at least one energy source (block 1303).

The method also includes adjusting, by the one or more inverter circuits, the output AC voltage levels of the power grid based on output power levels of the one or more inverter circuits (block 1304). In some embodiments, adjusting the voltage levels of the power grid includes tracking respective maximum power levels output by all or some subset of the inverter circuits, and adjusting the output AC voltage levels of the power grid based on the respective maximum power levels. In other embodiments, adjusting the AC voltage levels on the power grid includes adjusting the voltage level of the power grid based on respective preset power points for the output power levels of each of the one or more inverter circuits. In some other embodiments, once equilibrium has been reached between loads connected to the power grid and power generated by the one or more variable energy sources, the adjusting the voltage levels of the power grid can involve adjusting the output AC voltage levels to maintain the power provided by the one or more variable energy sources. The method concludes in block 1305.

FIG. 14 illustrates a functional diagram of an inverter in accordance with an example implementation. The proposed inverter can involve, but is not limited to, a microcontroller 1401, an interface (I/F) 1402, a voltage source inverter 1403, an AC voltage controller 1404, capacitors 1405, inductors 1406, memory 1407, transformer 1408, and a semiconductor-based relay or switch 1409. The proposed inverter can receive input time-varying DC voltage from a corresponding renewable energy source that may have varying voltage levels. For example, fluctuations in cloud patterns may affect the illumination provided to solar panels, variations in wind will affect the power output of wind turbines, etc. Voltage source inverter 1403 is used to convert the input time-varying DC voltage to output time-varying AC voltage. AC voltage controller 1404 is configured to control the voltage amplitude of the output time-varying AC voltage based on instructions from the microcontroller 1401.

Depending on the desired implementation, the inverter can also be connected to an external controller (e.g., control circuits 708, 808) that also regulates the load circuits of the power grid. Such an external controller can provide a control signal to be received by I/F 1402 and stored into memory 1407. The control signal can include information such as, but not limited to, a set nominal voltage for the inverter, the impedance from one or more load circuits connected to the power grid, and/or a number of energy systems connected to the power grid by the one or more load circuits, maximum/preset power levels, and so on in accordance with the desired implementation.

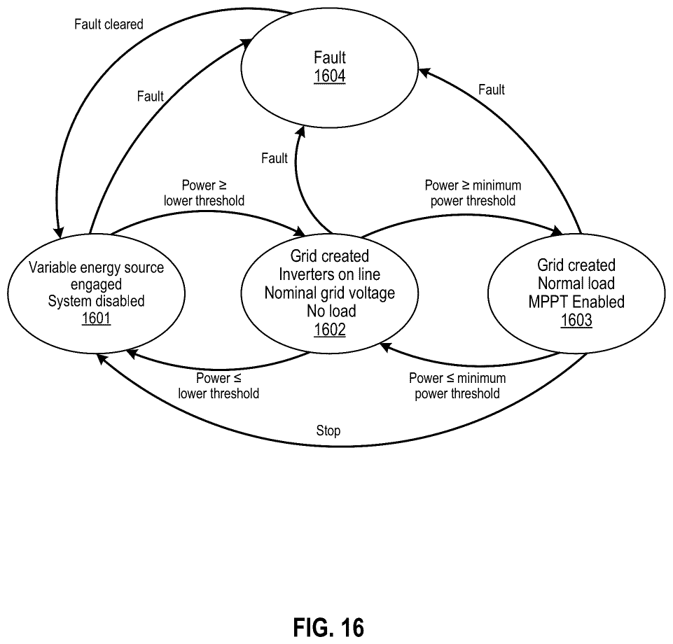

Microcontroller 1401 can be configured to calculate the maximum power provided by the renewable energy source based on the time-varying input DC voltage levels through information about tracked generator power 709A-709C, and can also adjust the output time-varying AC voltage levels. For example, given the input DC voltage level, there can be set power points corresponding to the power level of the underlying renewable energy source as illustrated in FIG. 15. FIG. 15 illustrates examples of ranges of input DC voltage levels from which a power level is derived and mapped to corresponding output power points that can be used by the microcontroller 1401 to adjust the output AC voltage. However, other power tracking algorithms, such as MPPT as described herein, can also be used and the present disclosure is not limited thereto.

Memory 1407 can be configured to store control signals, information about tracked generator power 709A-709C, and can also store management information regarding voltage levels to be set based on the power calculated by the microcontroller 1401 (e.g., voltage amplitude to be set based on power in), such as the management information illustrated in FIG. 15.

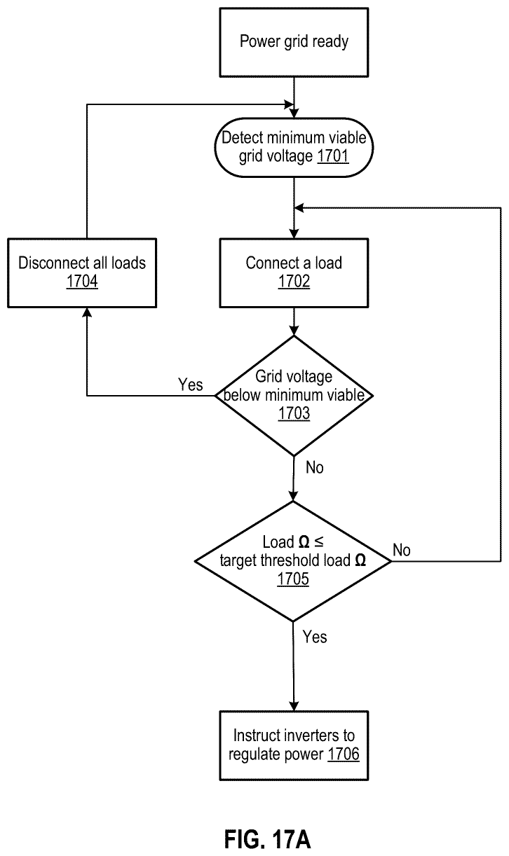

FIG. 16 illustrates an example state diagram for power grid regulation, in accordance with an example implementation. Specifically, FIG. 16 illustrates an example state diagram for the proposed system at start-up. At first, the variable energy source may be taking in power at 1601 while the system is disabled. During start-up mode, the inverters can form, or connect to, the power grid and transmit a message to the controller (e.g., via I/F 1402) to indicate that the system is online as shown at 1602. In another embodiment, the controller can be informed that the system is online based on measuring the output power from the inverters, so that the inverters do not have to communicate directly to the load controller.

Due to the variability of the underlying renewable energy source, a specific voltage level can be defined for each renewable energy source to ensure that the power generation is sufficient (e.g., above 10% of the nominal power) to generate a voltage. The voltage level can be set in accordance with the characteristics of the underlying renewable energy source. When sufficient power is being generated by the underlying renewable energy source, then the corresponding inverter can connect to, or coordinate with other inverters to form, a power grid. At the start up mode as shown at 1602, the thermal energy storage systems are not engaged yet, so there is no load present on the power grid. In some embodiments, the power grid may be a microgrid.

Once a stable grid has been established or created, and the inverters synchronize to a minimum set voltage (e.g., the total voltage of the inverters meets the set nominal voltage), the load controller can begin to connect loads to the microgrid, by means including mechanical or semiconductor switches, adjustment of electrodes, or other means. The load controller may monitor the microgrid voltage and lower impedance when the microgrid voltage is above an upper value, and raise impedance when the microgrid voltage is below a lower value, as shown at 1603. In the embodiments described herein, the electrical heaters may be disconnected by the one or more load circuits if the microgrid does not meet the minimum power threshold to maintain or preserve microgrid voltage with the highest possible impedance connected (e.g., voltage level falls below the nominal voltage level). Similarly, if insufficient power is generated by the renewable energy source, then the system can be disabled as shown at 1601. If there are any faults that occur in the system, such faults can be handled by a fault process 1604 in accordance with the desired implementation.

FIG. 17A illustrates an example flow diagram for a load controller that is configured to interact with the one or more load circuits, in accordance with an example implementation. The flow is conducted by the load controller at the start of the power grid formation to ensure that the power grid is established with a nominal power level available for the renewable energy source to supply the power grid, which (as with the above embodiments) may be a microgrid. Depending on the desired implementation, the controller can send a control signal to the inverters to indicate that the thermal energy storage system has been connected to the grid by the load circuits (e.g., via communicating the impedance, the number of thermal energy storage systems connected to the grid, a binary signal to maximize power, etc.) and that the grid has sufficient capacity to power the load. In response, the inverters can attempt to maximize power provided from their respective renewable variable energy sources. Depending on the desired implementation, each inverter can execute an internal algorithm to optimize power delivery whenever the demand placed on them by the connected thermal energy storage system exceeds the input power from the underlying renewable energy source and a request from the load controller has been received.

At 1701, the load controller detects that the power grid meets the minimum viable grid voltage (e.g., the output time-varying AC voltage is within a threshold of the set nominal voltage). At 1702, the load controller connects a thermal energy storage system or other desired load to the power grid by controlling the corresponding load circuits. At 1703, the load controller checks to determine whether the voltage level of the power grid is below the minimum viable voltage. If so (“Yes” at 1703) then the controller proceeds to 1704 to disconnect all loads, since the power being produced by the renewable energy sources is less than the desired nominal power.

Otherwise (“No” at 1703), the load controller checks if the impedance of the load is less than the target threshold (maximum desired) load impedance. If not (“No” at 1705), then the load controller proceeds to 1702 to connect another thermal energy storage system by connecting a corresponding load circuit to reduce the impedance. Otherwise (“Yes” at 1705), the controller proceeds to 1706 to instruct inverters to regulate power (e.g., maximize or maintain) from their respective renewable energy sources.

In example embodiments described herein, the load controller can be part of the thermal energy storage system and configured to control the load circuits associated with the thermal energy storage system as shown in FIGS. 7 and 8.

FIG. 17B is an alternative flow diagram for the load controller in accordance with another example implementation. At first, once the grid has reached a steady state, a minimum load is connected at 1720. At 1721, a determination is made as to whether the output AC voltage level is above the minimum viable voltage. If not (No), then a determination that there is not sufficient energy to connect the load is made at 1722, and the flow will try again at 1720 after some preset time has passed.

Otherwise (Yes), the flow proceeds to 1723, wherein a determination is made as to whether the grid voltage is at or greater than the maximum voltage for the grid. If so (Yes), then load selection is enabled at 1724 to engage another load. Otherwise (No) the flow proceeds to 1725 to decide as to whether the voltage level is within the optimal range as defined for the grid. (Note that the symbol € signifies “is within”.) If so (Yes), then the flow proceeds to 1726; otherwise (No) the flow proceeds to 1728.

At 1726, the voltage is monitored. At 1727, a determination is made as to whether the voltage is within the optimal range based on the monitoring. If not (No), then the flow proceeds to 1723, otherwise (Yes) the flow continues to monitor the voltage at 1726. The voltage monitoring can be carried out continuously, or at a periodic rate sufficient to sample the voltage in time to detect changes essentially as the occur, e.g. multiple samples for each minimum expected period of time during which the voltage may change. As an example, if for a given system the voltage is expected or designed to change at a rate of 10 Hz (i.e. with a period of 100 milliseconds), then the voltage monitoring step can be carried out with a periodicity on the order of less than 100 milliseconds, such that the voltage is monitored several times per 100 millisecond period.

At 1728, a determination is made as to whether the minimum load is present. If so (Yes), then the flow proceeds to 1732; otherwise (No) the flow proceeds to 1729 to disconnect a load section.

At 1730, a determination is made as to whether the voltage is within the optimal range. If so (Yes), then the flow proceeds to 1726 to monitor the voltage, otherwise (No), the flow proceeds to 1731 to determine if a minimum load is present. If so (Yes) then the flow proceeds to 1732, otherwise (No) the flow proceeds to 1729.

At 1732 a determination is made as to whether the voltage is within the operating range. If so (Yes), then the flow proceeds back to 1723, otherwise (No) the flow proceeds to 1733 to disconnect the load section.

At 1734, a determination is made as to whether the voltage is within the operating range. If so, (Yes), then the flow waits for a preset period of time before attempting to connect a load again at 1720, otherwise (No), the system shuts down.

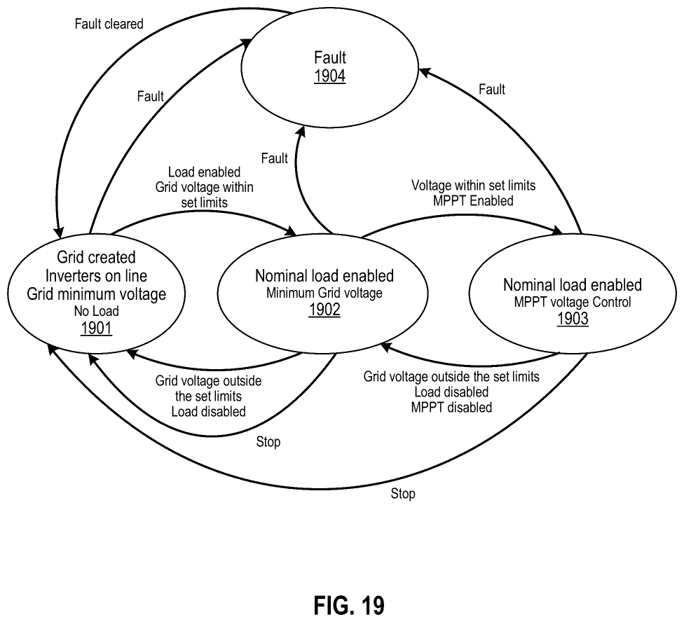

FIG. 18 illustrates an example impedance and load power level management information that can be referenced by the controller, in accordance with an example implementation. In example implementations, the controller can adjust the impedance at the load circuits so that it can maximize the power to be received by the thermal energy storage system. FIG. 18 illustrates examples of impedances that can be set and the corresponding power expected from the inverters. The power level of the power grid can be managed by programming the controller to set the impedance corresponding to the desired power level through engaging the load circuits.

Depending on the desired implementation, the controller can prioritize the highest load (lower impedance) to absorb as much of the available power as possible within the defined voltage operating limits and current limits of the inverter. The controller can thereby perform its duties with very minimal control/status interaction with the inverters and renewable energy sources. The controller can further enable or disable resistors in parallel to the microgrid lines to achieve the desired impedance through the use of load circuits. In addition, the controller can monitor the voltage of the power grid, and if voltage is below the minimum stable threshold limit, then the load is shut off.

Depending on the desired implementation, the controller can involve additional functions to match the load to the capabilities of the renewable energy sources and inverters. In case the inverters cannot form a power grid or deliver a voltage level to the power grid at the set nominal voltage level, the controller can restart the system at a reduced load or with loads disabled. The MPPT algorithm at the inverters then output voltage levels to maximize power. The controller can monitor the voltage range of the power grid and maintain the load. Such a situation can occur, for example, for a solar array that is covered in clouds, or is not illuminated due to the time of day.

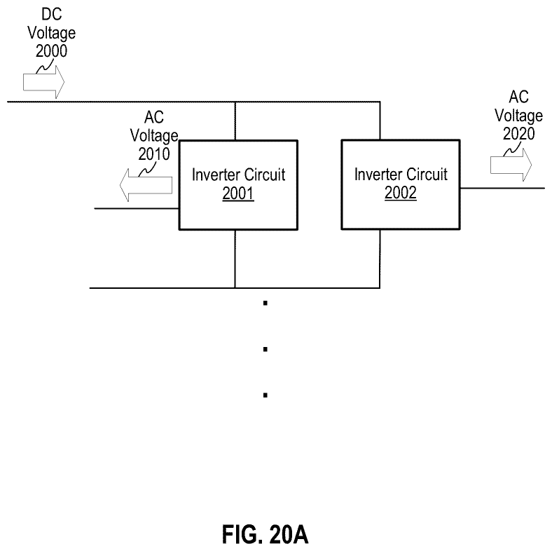

FIG. 19 illustrates an example state diagram for the thermal energy storage system, in accordance with an example implementation. In example implementations described herein, the load controller can directly measure the output time-varying AC voltage at the power grid and use the value to make control decisions. When the observed voltage is at or above a set nominal voltage or within a range of a target voltage (e.g., above 10% of the set nominal voltage and below 105% of the set nominal voltage) the target resistance shall be the maximum or desired load (i.e., reducing the impedance to maximize power intake). The overall transition between the states is given by the electrical properties of the impedance and power level of the renewable energy sources and can be described as transition between power levels of the renewable energy sources. For example, if the renewable energy sources generate more than 1% of the nominal power, then the system can be operable. If the renewable energy sources generate less, then the load circuits are disconnected.

When the observed voltage is below a set nominal voltage or below a threshold of such (e.g., below 10% of the set nominal voltage) the controller disconnects the load. Loads can be reconnected based on the flow diagram as illustrated in FIG. 17A and FIG. 17B.

The controller can also be configured to meet other system requirements while it operates including balancing power across the various phases, and placing heat where it is needed within the thermal energy storage system.

Once the power grid is online or created and the inverters are producing the set nominal voltage, at first there is no load attached as shown at 1901. If the grid voltage is within set limits (e.g., it meets the set nominal voltage) then the thermal energy storage system can be connected by its corresponding load circuits as shown at 1902. If the connection of the thermal energy storage system causes the grid voltage to fall below a set nominal voltage, it indicates that there is insufficient power to engage the load, and the load is thereby disabled. Once the desired load is established and the voltage is within the set limits (e.g., meeting the set nominal voltage) then the inverters proceed to maximize power through voltage control as shown at 1903. Should any faults occur, then a fault process can be initiated in accordance with the desired implementation as shown at 1904.

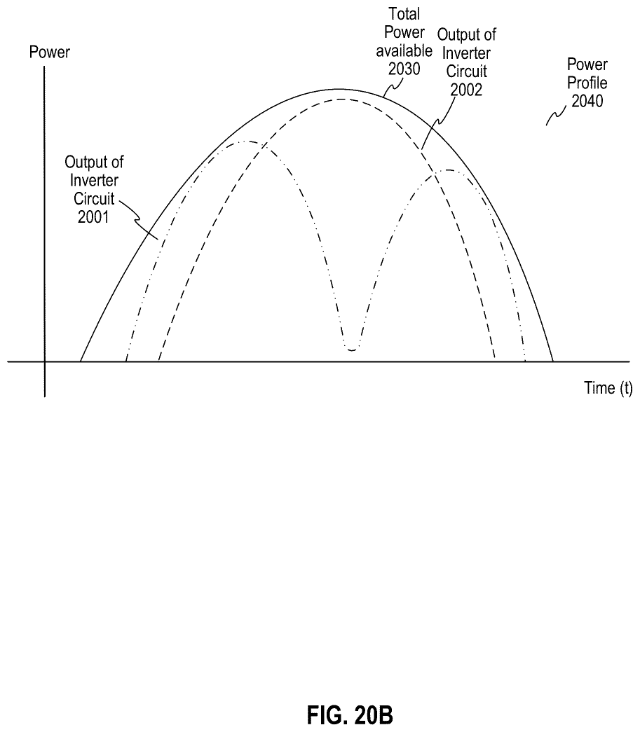

FIG. 20A illustrates an example embodiment involving utilizing multiple inverters to distribute power across multiple power grids from an underlying variable energy source—in this example, from a variable energy source providing DC voltage 2000. In this embodiment, a first inverter circuit 2001 provides output AC voltage 2010 to a first grid (e.g., an external power grid or microgrid, not separately shown), and second inverter circuit 2002 providing output AC voltage 2020 to a second grid (again, possibly an external power grid or microgrid, not separately shown). The power distribution can be controlled by one inverter circuit (e.g. inverter circuit 2002) based on a priority required for one of the grids, while the other inverter circuit (e.g. inverter circuit 2001) can be curtailed to meet the power demand of the higher priority grid (in this example, the grid connected to inverter circuit 2002). To manage the maximum desired power for the higher priority grid, the load controller in the lower priority grid can remove load (to raise impedance) so that the voltage rise in the higher priority grid curtails the other inverter circuit. Such management can also be achieved by transmitting a command from the generator controller to the inverter circuits, in accordance with the desired implementation.

In such an example, it is also possible to configure the inverter circuits to operate in different control modes to facilitate the desired functionality of their corresponding grid. For example, one of the inverter circuits 2001 can be configured to operate in voltage control mode as described in the embodiments herein, whereas the other inverter circuit 2002 can be configured to operate in current control mode, to facilitate the expected functionality of its underlying grid.

FIG. 20B illustrates an example power profile for the inverter circuit implementation of FIG. 20A. As shown in the power profile 2040 of the two inverters, based on the total power available 2030 from the underlying variable energy source, the output of the inverter circuits can be managed from load control based on the grid priority. FIG. 20B illustrates the curtailment of energy via Inverter Circuit 2001 while maintaining the output of Inverter Circuit 2002.

Through such an embodiment, it is possible to have multiple inverters on a single variable energy source string that delivers power for different purposes. The multiple inverter circuits can be tied in parallel to a single DC system (e.g., one or more solar loops, wind turbines, etc.). At a first time, a first inverter is commanded to deliver power up to a maximum output delivery, and a second inverter delivers only power which could not have been delivered by the first inverter (e.g., the microcontroller of the second inverter circuit executing MDPT recognizes that more power is available than can be delivered by the first inverter, and controls the second inverter to deliver energy up to that power limit). Depending on the desired implementation, the roles can also be reversed whereby the second inverter is output power limited and the first inverter is source power limited.

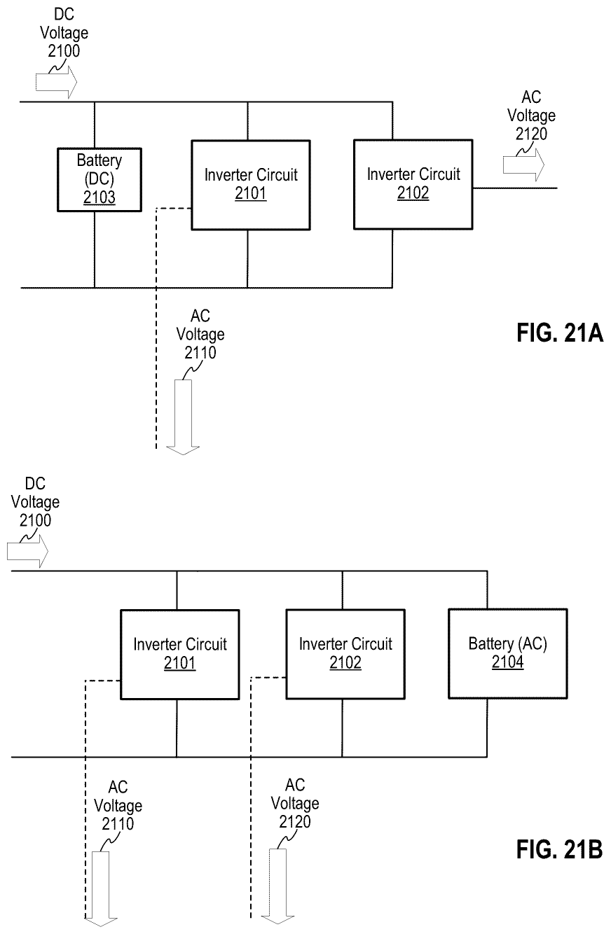

FIGS. 21A and 21B illustrate another example embodiment involving multiple inverter circuits for an underlying variable energy source. In this example embodiment, a battery can be connected on the variable energy source side (DC) or on the grid side (AC) to provide charge control if additional power is needed. In the example of FIG. 21A, inverter circuit 2102 provides output AC voltage 2120 to its connected grid and inverter circuit 2101 provides AC voltage 2110 to its connected grid based on the DC voltage 2100 provided from the underlying variable energy source. Battery 2103 illustrates an example in which additional power is provided on the DC side (along with the variable energy source) to facilitate the multiple inverter circuit, multiple grid implementation. Battery 2104 illustrates an example in which additional power is provided on the AC side (on the grid itself).

Through the example embodiments described herein, a system for voltage regulation of a power grid with load circuits coupled to the power grid can be achieved. Such a system can involve one or more inverter circuits (e.g., as part of inverter circuit array 702, 802 composed of inverters 901A to 901C, or 1001A to 1001C) configured to receive a plurality of input direct current (DC) voltage levels (e.g., measured from DC voltages 707A to 707C, 807A to 807C, 907A to 907C, or 1007A to 1007) from one or more variable energy sources (e.g., generator circuits 701A to 701C, or 801A to 801C with underlying renewable energy sources); and generate an output alternating current (AC) voltage levels (e.g., output voltage 706, 806 as aggregated from each inverter circuit 901A to 901C, or each inverter circuit 1001A to 1001C), on the power grid (e.g., power grid/microgrid 705, 805) based upon power levels (e.g., P_{renewable} as measured by microcontroller 1401) of the input DC voltages levels; and adjust the output AC voltage levels to the power grid based on respective available power levels received from the one or more variable energy sources, to regulate output power from the power grid for distribution to the one or more load circuits. The regulation of the output power can involve maximizing the power by varying output AC voltage level V given a lowering of the impedance of the load circuits R while harnessing more power from the underlying variable energy source, or maintaining a voltage V given the input power levels from the variable energy sources P_{renewable} and the load impedance of the load circuits R.

In the example system for voltage regulation of a power grid with load circuits coupled to the power grid as described herein, to adjust the output AC voltage levels to the power grid, the inverter circuits (e.g., as part of inverter circuit array 702, 802 composed of inverters 901A to 901C, or 1001A to 1001C) may be configured to track the available power levels received from the one or more variable energy sources (e.g., via by tracked generator power 709A-709C as managed by microcontroller 1401 through algorithms or by management information illustrated in FIG. 15) and adjust the output AC voltage levels based on the tracked available power levels to regulate the output power from the power grid to the load circuits.

The variable energy sources can all be of a same type (i.e., homogenous) of renewable energy source. Examples of such heterogeneous variable energy sources can involve, but are not limited to, solar panels with photovoltaic cells 811 on a solar farm, wind turbines 812 on a wind farm, hydroelectric turbines for a dam or waterfall, geothermal energy sources, tidal energy sources, and so on. Depending on the desired implementation, such variable energy sources can all be homogeneous if the inverter circuit array is being utilized for a localized energy source. However, the one or more variable energy sources can also involve heterogenous renewable energy sources which incorporate any combination of the above described renewable energy sources so that one type of variable energy source managed by the system is different from another type of variable energy source. Accordingly, the system described herein can be flexibly deployed among any configuration of renewable energy sources.

The inverter circuits can be further configured to adjust the output AC voltage levels based on respective preset power points for power levels received from the one or more variable energy sources as illustrated from referencing the management information in FIG. 15. Once the input DC voltage level is known, the power levels for the underlying energy source can be determined based on current or impedance, and the power point can be referenced according to the management information.

The load circuits may include a heating element 1101 configured to heat a thermal energy storage medium 1102 using the output AC voltage levels to the power grid 1103. The heating element 1101 can be configured to convert the output AC voltage received from the one or more inverter circuits into thermal energy which is then used to heat the thermal energy storage medium 1102 through the processes as described with respect to FIGS. 1-6. Load circuits can also involve other types of loads, such as one or more electrode boilers that are configured to adjust electrode positions or water levels in response to the output AC voltage levels, one or more variable frequency drives (VFDs) controlling motors configured to drive: heat pumps in response to the output AC voltage levels; one or more electric furnaces to heat up in response to the output AC voltage levels; one or more heating modules; any suitable single/multiple combinations of the foregoing; and so on.

The variable energy sources can include a geothermal energy generator configured to generate time-varying DC voltage based on variation in heat extraction, at least one solar panel configured to generate a time-varying DC voltage based on illumination of the solar panel, a wind turbine configured to generate a time-varying DC voltage based on turning of the wind turbine, a hydroelectric turbine configured to generate a time-varying DC voltage based on the turning of the hydroelectric turbine, a tidal energy generator configured to generate time-varying DC voltage based on flow of tidal water through a tidal energy generator device or a buoyancy of a float in a tidal energy device that is subject to fluctuations in water height caused by tides, and or other variable energy sources in accordance with the desired implementation. As noted in these examples, the variable energy source can be a renewable energy source that operates in an intermittent manner, such as solar based (e.g., varies based on illumination or time of day), wind based (e.g., varies based on wind speed), hydroelectric (e.g., varies based on release of water from the dam), and so on, whereupon the system can thereby adjust the output AC voltage level accordingly based on the power being drawn from the underlying source. The variation can be determined from the input time-varying DC voltage levels, which will fluctuate accordingly.

To adjust the output AC voltage levels of the power grid, the inverter circuits may be configured to adjust the output AC voltage levels based on an impedance of the one or more load circuits coupled to the power grid, as illustrated in the management information table of FIG. 18. The load impedance can be transmitted to the one or more inverter circuits via control signals 810, and the one or more inverter circuits can also store such information in memory 1407. Once the microcontroller 1401 receives the load impedance via the control signal 710 or 810, the microcontroller 1401 can then reference the management information of FIG. 18 as retrieved from memory 1407 to determine the desired power level to be output, and then extract additional power from the underlying energy source or adjust the output AC voltage level to meet the power level. In another embodiment, the number of loads can be transmitted to the one or more inverter circuits via control signal 710 or 810 instead, and the management information can be modified to reference power to be driven based on number of loads connected to the power grid 705 or 805 by the load circuits 703 or 803.

The load controller (e.g., control circuit 708, 808 or the like) may be configured to disconnect a first set of loads from the power grid in response to the output AC voltage levels falling below a set nominal voltage level, as illustrated at 1703 and 1704; and connect a second set of loads to the power grid in response to the output AC voltage levels climbing beyond a target threshold, as illustrated at 1702.

The inverter circuits may be configured to adjust the output AC voltage levels based on available power levels received from the variable energy sources, to regulate output power from the power grid to the load circuits by maximizing the output power from the power grid to the load circuits, as illustrated in the state diagram of FIG. 16 and the flow diagram of FIG. 17A. The inverter circuits can also be configured to maximize the power drawn from the variable energy sources so that a maximum number of loads (e.g., thermal storage media) can be engaged to the power grid.

The inverter circuits can be configured to adjust the output AC voltage levels based on available power levels received from the variable energy sources, to regulate output power from the power grid to the load circuits by maintaining the output power from the power grid to the load circuits at a substantially constant level within a selected range (i.e., at or above a selected, predefined minimum threshold and at or below a selected, predefined maximum threshold). Once an equilibrium has been maintained, the inverter circuits can maintain the output AC voltage level in the desired range as long as the power from the underlying variable energy sources support the output AC voltage level.

In an example system for voltage regulation of a power grid such as a microgrid with load circuits coupled to the power grid, a load controller (e.g., load controller 713, 813) is configured to control the load circuits to lower microgrid impedance by connecting one or more loads in response to the output AC voltage rising above a maximum voltage level; and to control the load circuits to raise microgrid impedance by disconnecting one or more loads in response to the output AC voltage falling below a minimum target voltage level. Configurations and processes for such operations are depicted in FIGS. 11B-11D, 17A, 17B, and 19.

Depending on the desired implementation, the loads can include at least one thermal energy storage medium and one or more heating elements configured to heat the thermal energy storage medium from input electrical energy from the load circuits as illustrated in FIG. 11A.

As illustrated in FIG. 11D, the loads may also or alternatively include one or more electrode boilers 1120 configured to adjust positions of electrodes or adjust water levels based on input electrical energy from the load circuits, and/or one or more electric furnaces 1121 configured to generate heat based on input electrical energy from the load circuits.

In the example system for voltage regulation of the power grid as described herein, the load controller can be configured to control the load circuits through controlling one or more power-switching devices configured to connect or disconnect the load to the power grid, as illustrated in FIG. 11B. Depending on the desired implementation, the one or more power-switching devices can include thyristors as illustrated in FIG. 11B.

Multiple inverter circuits (e.g., inverter circuit array 702, 802) may be provided, configured to: receive input direct current (DC) power (e.g., P_{renewable}) from one or more variable energy sources; generate output alternating current (AC) voltage levels on the power grid based upon power levels of the input DC power from the one or more variable energy sources; and adjust the output AC voltage levels to deliver power to the power grid based on power levels available from the one or more variable energy sources as shown in FIGS. 7 and 8.

Thus, in accordance with the above, a number of system implementations are possible and contemplated, for which a number of examples are now provided.

In the example system for voltage regulation of the power grid as described herein, there can be a first set of the multiple inverter circuits associated with a first set of the one or more variable energy sources that are configured with a first maximum operating voltage (e.g., V1), and wherein a second set of the multiple inverter circuits corresponding to a second set of the one or more variable energy sources that are configured with a second maximum operating voltage (e.g., V2), wherein the second maximum operating voltage is greater than the first maximum operating voltage as described with respect to FIGS. 9 and 10.

In the example system for voltage regulation of the power grid as described herein, there can be another set of multiple inverter circuits connected in parallel to the multiple inverter circuits, configured to receive input direct current (DC) power from the one or more variable energy sources; and generate output alternating current (AC) voltage levels to another power grid based upon power levels of the input DC power as illustrated in FIGS. 20A, 21A, and 21B. Depending on the desired implementation, the another set of multiple inverter circuits connected in parallel to the multiple inverter circuits operate can operate current control mode.

In the example system for voltage regulation of the power grid as described herein, there can further include a battery connected between the one or more variable energy sources and the multiple inverter circuits in parallel, the battery configured to provide additional input DC power in addition to the variable energy sources for when the input DC power is below a minimum viable threshold as illustrated in FIG. 21A.

In the example system for voltage regulation of the power grid as described herein, there can further include a battery connected between the one or more variable energy sources and the multiple inverter circuits in parallel, the battery configured to provide additional output AC voltage levels to the power grid for when the output AC voltage levels are below a minimum viable threshold as illustrated in FIG. 21B. In some embodiments of the example system of FIGS. 21A-21B, the power grid may be a microgrid.

In the example system for voltage regulation of the power grid as described herein, to adjust the output AC voltages levels, a first set of the multiple inverter circuits can be configured to track the available power levels received from the one or more variable energy sources; and adjust the output AC voltage levels based on the tracked available power levels to maximize power delivery to the power grid as described with respect to FIGS. 9 and 10.

In the example system for voltage regulation of the power grid as described herein, to adjust the output AC voltages levels to the power grid, a second set of the multiple inverter circuits can be configured to track the available power levels received from the one or more variable energy sources; track the power delivery of the first set of the multiple inverters; and received from the one or more variable energy sources and adjust the output AC voltages to deliver power up to the available power levels for when the power delivery of the first set of the multiple inverters is below the available power levels as described with respect to FIGS. 9 and 10. In this manner, one set of inverter circuits can be configured to provide maximum power while the other set (e.g., a later constructed system) is used to hold off or provide extra power based on the power output of the first set of inverter circuits.

In a power grid interconnecting thermal energy storage systems to variable renewable energy sources, the embodiments described herein can thereby match available power from the variable renewable energy sources or achieve the desired power by a higher-level controller with very high fidelity. In at least some embodiments of the foregoing example systems, the power grid may be a microgrid. Although some examples herein are described in the context of a microgrid, it should also be understood that other types of power grids or electrical networks are not excluded, such as those that can function suitably with voltage variation or modulation.

Further, the embodiments described herein facilitate the ability to control the consumption of low levels of power with low impedance (high power) load while eliminating the need for extra equipment to conduct the power regulation. This allows for seamless power control at any level especially when the embodiments described herein are combined with a load enabling and disabling feature leading to cost efficient high precision solution.

In addition, the embodiments described herein facilitate the ability to have uninterrupted power when the power level is smaller than the nominal load rating by reducing the working voltage. Thus, the power regulation can reduce the aging of the thermal energy storage systems while providing a wider level of control.

To the extent a term used in a claim is not defined below, it should be given the broadest definition persons in the pertinent art have given that term as reflected in printed publications and issued patents at the time of filing. For example, the following terminology may be used interchangeably, as would be understood to those skilled in the art:
A Amperes
AC Alternating current
DC Direct current
DFB Dual Fluidized Bed
EAR Enhanced Oil Recovery
EV Electric vehicle
GT Gas turbine
HRSG Heat recovery steam generator
kV kilovolt
kW kilowatt
MED Multi-effect desalination
MPPT Maximum power point tracking
MSF Multi-stage flash
MW megawatt
OTSG Once-through steam generator
PEM Proton-exchange membrane
PV Photovoltaic
RSOC Reversible solid oxide cell
SOEC Solid oxide electrolyzer cell
SOFC Solid oxide fuel cell
ST Steam turbine
TES Thermal Energy Storage
TSU Thermal Storage Unit

Additionally, the term “heater” is used to refer to a conductive element that generates heat. For example, the term “heater” as used in the present example implementations may include, but is not limited to, a wire, a ribbon, a tape, or other structure that can conduct electricity in a manner that generates heat. The composition of the heater may be metallic (coated or uncoated), ceramic or other composition that can generate heat.

While foregoing example implementations may refer to “air”, including CO₂, the inventive concept is not limited to this composition, and other fluid streams may be substituted therefor for additional industrial applications. For example, but by way of limitation, enhanced oil recovery, sterilization related to healthcare or food and beverages, drying, chemical production, desalination and hydrothermal processing (e.g. Bayer process.) The Bayer process includes a calcination step. The composition of fluid streams may be selected to improve product yields or efficiency, or to control the exhaust stream.

In any of the thermal storage units, the working fluid composition may be changed at times for a number of purposes, including maintenance or re-conditioning of materials. Multiple units may be used in synergy to improve charging or discharging characteristics, sizing or ease of installation, integration or maintenance. As would be understood by those skilled in the art, the thermal storage units disclosed herein may be substituted with other thermal storage units having the necessary properties and functions; results may vary, depending on the manner and scale of combination of the thermal storage units.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain example implementations herein is intended merely to better illuminate the example implementation and does not pose a limitation on the scope of the example implementation otherwise claimed. No language in the specification should be construed as indicating any non-claimed element essential to the practice of the example implementation.

Groupings of alternative elements or example implementations of the example implementation disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

In the specification, reference may be made to the spatial relationships between various components and to the spatial orientation of various aspects of components as the devices are depicted in the attached drawings. However, as will be recognized by those skilled in the art after a complete reading of the present application, the devices, members, devices, etc. described herein may be positioned in any desired orientation. Thus, the use of terms such as “above,” “below,” “upper,” “lower,” “first”, “second” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

In interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various example implementations of the example implementation, other and further example implementations of the example implementation may be devised without departing from the basic scope thereof. The scope of the example implementation is determined by the claims that follow. The example implementation is not limited to the described example implementations, versions or examples, which are included to enable a person having ordinary skill in the art to make and use the example implementation when combined with information and knowledge available to the person having ordinary skill in the art.

What is claimed is:

1. A system for voltage regulation of a power grid with load circuits coupled to the power grid, including:
one or more inverter circuits, configured to:
receive input direct current (DC) voltage from at least one variable energy source;
generate output alternating current (AC) voltage levels on the power grid based upon power levels of the one or more variable energy sources; and
adjust the output AC voltage levels based on available power levels of the one or more variable energy sources, to regulate output power from the power grid to the load circuits.

2. The system of claim 1, wherein the inverter circuits are configured to:
track the available power levels of the one or more variable energy sources; and
adjust the output AC voltage levels based upon the tracked available power levels and thereby regulate the output power from the power grid to the load circuits.

3. The system of claim 1, wherein the one or more variable energy sources includes a renewable energy source.

4. The system of claim 1, wherein the one or more variable energy sources includes at least two different types of renewable energy sources.

5. The system of claim 1, wherein inverter circuits are configured to adjust the output AC voltage levels based on respective preset power points for the available power levels received from the one or more variable energy sources.

6. The system of claim 1, wherein the load circuits include a heating element configured to heat a thermal energy storage medium using the output AC voltage levels.

7. The system of claim 1, wherein the load circuits include one or more electrode boilers that are configured to adjust electrode positions or water levels in response to the output AC voltage levels.

8. The system of claim 1, wherein the one or more variable energy sources includes at least one solar panel configured to generate a time-varying DC voltage based on illumination of the solar panel.

9. The system of claim 1, wherein the one or more variable energy sources includes a wind turbine configured to generate a time-varying DC voltage based on a rate of rotation of rotor blades of the wind turbine.

10. The system of claim 1, wherein the one or more inverter circuits is configured to adjust the output AC voltage levels based on an impedance of the load circuits.

11. The system of claim 10, further including a controller configured to generate a control signal representing the impedance of the load circuits and to provide the control signal to the one or more inverter circuits.

12. The system of claim 1, wherein the one or more inverter circuits is configured to adjust the output AC voltage levels based on a number of loads connected by the load circuits.

13. The system of claim 12, further including a controller configured to generate a control signal representing the number of the loads and to provide the control signal to the one or more inverter circuits.

14. The system of claim 1, further including a load controller, configured to:
disconnect a first set of loads from the load circuits when the output AC voltage levels fall below a set nominal voltage level; and
connect a second set of loads to the load circuits when the output AC voltage levels is above a predefined threshold.

15. The system of claim 1, wherein the inverter circuits are configured to adjust the output AC voltage levels based upon available power levels of the one or more variable energy sources, and thereby to regulate output power from the power grid to the load circuits by maximizing the output power from the power grid to the load circuits.

16. The system of claim 1, wherein the inverter circuits are configured to adjust the output AC voltage levels based on available power levels of the one or more variable energy sources, and thereby to regulate output power from the power grid to the load circuits by maintaining the output power from the power grid to the load circuits at a level within an operating range.

17. The system of claim 1, wherein the load circuits include one or more electric furnaces.

18. A method for voltage regulation of a power grid to which load circuits are coupled, the method including:
receiving, at one or more inverter circuits, input direct current (DC) voltage from one or more variable energy sources;
generating, by the one or more inverter circuits and using the input DC voltage, output alternating current (AC) voltage levels;
providing the out AC voltage levels to the power grid; and
adjusting, by the one or more inverter circuits, the output AC voltage levels, based upon available power levels of the one or more variable energy sources, to regulate output power from the power grid to the load circuits.

19. The method of claim 18, wherein the step of adjusting the output AC voltage levels includes:
tracking the available power levels of the one or more variable energy sources; and
adjusting the output AC voltage levels based upon the tracked available power levels.

20. The method of claim 18, wherein the one or more variable energy sources includes a renewable energy source.

21. The method of claim 18, wherein the one or more variable energy sources includes at least two different types of renewable energy sources.

22. The method of claim 18, wherein the adjusting the output AC voltage levels includes adjusting the output AC voltage levels based on respective preset power points for the available power levels of the one or more variable energy sources.

23. The method of claim 18, wherein the load circuits include a heating element configured to heat a thermal energy storage medium using the output AC voltage levels.

24. The method of claim 18, wherein the load circuits include one or more electrode boilers that are configured to adjust electrode positions or water levels in response to the output AC voltage levels.

25. The method of claim 18, wherein the one or more variable energy sources includes at least one solar panel configured to generate a time-varying DC voltage based on illumination of the solar panel.

26. The method of claim 18, wherein the one or more variable energy sources includes a wind turbine configured to generate a time-varying DC voltage based on turning of the wind turbine.

27. The method of claim 18, wherein the adjusting the output AC voltage levels includes adjusting the output AC voltage levels based on an impedance of the load circuits.

28. The method of claim 27, further including generating, using a controller, a control signal representing the impedance of the load circuits and providing said control signal to the one or more inverter circuits.

29. The method of claim 18, wherein the step of adjusting the output AC voltage levels includes adjusting the output AC voltage levels based upon a number of loads connected by the load circuits.

30. The method of claim 29, further including generating, using a controller, a control signal representing the number of loads and providing said control signal to the one or more inverter circuits.

31. The method of claim 18, further including:
disconnecting a first set of loads from the load circuits in response to the output AC voltage levels falling below a set nominal voltage level; and
connecting a second set of loads to the load circuits in response to the output AC voltage levels rising above a threshold.

32. The method of claim 18, wherein the step of adjusting the output AC voltage levels based upon available power levels of the one or more variable energy sources includes maximizing the output power from the power grid to the load circuits.

33. The method of claim 18, wherein the step of adjusting the output AC voltage levels based upon available power levels of the one or more variable energy sources includes maintaining the output power from the power grid to the load circuits at a level within a selected threshold range.

34. The method of claim 18, wherein the load circuits include one or more electric furnaces.

35. A system for voltage regulation of a power grid with load circuits coupled to the power grid, the system including a load controller, wherein the load controller is configured to:
control the load circuits to lower microgrid impedance by connecting one or more loads in response to AC voltage of the power grid rising above a maximum operating voltage level; and
control the load circuits to raise microgrid impedance by disconnecting one or more loads in response to the AC voltage of the power grid falling below a minimum operating voltage level.

36. The system of claim 35, wherein the one or more loads include:
at least one thermal energy storage medium; and
one or more heating elements configured to heat the thermal energy storage medium using input electrical energy from the load circuits.

37. The system of claim 35, wherein the one or more loads include one or more electrode boilers configured to adjust positions of electrodes or to adjust water levels, based upon levels of input electrical energy from the load circuits.

38. The system of claim 35, wherein the one or more loads include one or more electric furnaces configured to generate heat, using input electrical energy from the load circuits.

39. The system of claim 35, wherein the load controller is configured to control the load circuits by controlling one or more power-switching devices configured to connect or disconnect the loads to the power grid.

40. The system of claim 39, wherein the one or more power-switching devices include thyristors.

41. The system of claim 35, further including multiple inverter circuits configured to:
receive input direct current (DC) power from one or more variable energy sources;
generate output alternating current (AC) voltage levels on the power grid based upon power levels of the input power from the one or more variable energy sources; and
adjust the output AC voltage levels to deliver power to the power grid based upon power levels available from the one or more variable energy sources.

42. The system of claim 41, wherein:
a first set of the multiple inverter circuits associated with a first set of the one or more variable energy sources is configured with a first maximum operating voltage;
a second set of the multiple inverter circuits associated with a second set of the one or more variable energy sources is configured with a second maximum operating voltage; and
the second maximum operating voltage is greater than the first maximum operating voltage.

43. The system of claim 41, further including an additional set of multiple inverter circuits connected in parallel to the multiple inverter circuits, the additional set of multiple inverter circuits being configured to:
receive the input direct current (DC) power from the one or more variable energy sources; and
generate the output alternating current (AC) voltage levels to an additional power grid based upon power levels of the input DC power.

44. The system of claim 43, wherein the additional set of multiple inverter circuits connected in parallel to the multiple inverter circuits is configured to operate in current control mode.

45. The system of claim 41, further including a battery connected between the one or more variable energy sources and the multiple inverter circuits in parallel, the battery configured to provide additional input DC power in addition to the variable energy sources in response to the input DC power falling below a minimum viable threshold.

46. The system of claim 41, further including a battery connected between the one or more variable energy sources and the multiple inverter circuits in parallel, the battery configured to provide raised output AC voltage levels to the power grid in response to the output AC voltage levels falling below a minimum viable threshold.

47. The system of claim 41, wherein to adjust the output AC voltages levels, a first set of the multiple inverter circuits is configured to:
track available power levels received from the one or more variable energy sources; and
adjust the output AC voltage levels based on the tracked available power levels to maximize power delivery to the power grid.

48. The system of claim 47, wherein to adjust the output AC voltages levels to the power grid, a second set of the multiple inverter circuits is configured to:
track available power levels received from the one or more variable energy sources;
track power delivery of the first set of the multiple inverters; and
adjust the output AC voltages to deliver power up to the available power levels in response to the power delivery of the first set of the multiple inverters being below the available power levels.

49. A system for voltage regulation of a power grid and renewable energy storage systems with load circuits coupled thereto, including:
a thermal energy storage medium configured to store thermal energy;
a plurality of heating elements, each of the plurality of heating elements configured to heat the thermal energy storage medium through use of input electrical energy;
load circuits configured to connect or disconnect the heating elements to a power grid and to relay electrical energy from the power grid as the input electrical energy to the plurality of heating elements; and
one or more inverter circuits configured to:
receive input direct current (DC) voltage from one or more variable energy sources;
generate output alternating current (AC) voltage levels on the power grid based upon power levels of the input DC voltage levels; and
adjust the output AC voltage levels based on available power levels received from the one or more variable energy sources, to regulate output power from the power grid to the load circuits.
